(19) United States
(12) Patent Application Publication
(10) Pub. No.: US 2002/0024647 A1
(43) Pub. Date: Feb. 28, 2002

(54) Exposure apparatus, lithography system and conveying method, and device manufacturing method and device

(75) Inventors: Kanefumi Nakahara, Kumagaya-shi (JP); Ken Hattori, Okegawa-shi (JP); Yoshitomo Nagahashi, Takasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: NIKON CORPORATION, Tokyo (JP)

(21) Appl. No.: 09/935,734

(22) Filed: Aug. 24, 2001

Related U.S. Application Data
(63) Continuation of application No. PCT/JP00/01075, filed on Feb. 25, 2000.

(30) Foreign Application Priority Data
Feb. 26, 1999 (JP) 11-051,565
Feb. 26, 1999 (JP) 11-051,096
May 6, 1999 (JP) 11-126,065
Dec. 3, 1999 (JP) 11-344,050

(51) Int. Cl. G03B 27/42

(52) U.S. Cl. 355/53; 355/27; 355/72; 355/76; 118/52; 396/611

(57) ABSTRACT

A laser unit is arranged in an area of a floor surface, the width of which area is defined by maintenance areas, on both sides of an exposure-apparatus main body, inclusive. Furthermore, the exposure-apparatus main body and the laser unit are arranged on the floor surface such that maintenance areas of the both overlap each other at least partially. Moreover, a C/D is connected in-line with the front surface of the exposure-apparatus main body, and in the side of the exposure-apparatus main body, which side is in front of the optical axis of the projection optical system and which is connected with the C/D, a housing is provided which has a delivery port into and from which a mask container is loaded and unloaded by a ceiling-transport system that moves along a rail. Therefore, the laser unit is not further out into the maintenance areas than both side surfaces of the exposure-apparatus main body; the necessary area of the floor can be reduced, and the structure of a mask-transport system inside the exposure-apparatus main body can be prevented from becoming complicated.

### CROSS-REFERENCE TO RELATED APPLICATIONS

This is a continuation of International Application PCT/JP00/01075, with an international filing date of Feb. 25, 2000, the entire content of which being hereby incorporated herein by reference.

### BACKGROUND OF THE INVENTION

1. Field of the Invention

The present invention relates to an exposure apparatus, a lithography system and conveying method, and a device and manufacturing method thereof, and more specifically to an exposure apparatus used in a lithography process in the manufacturing of semiconductor devices, liquid crystal display devices or the like, a lithography system including the exposure apparatus, a conveying method suitable to transport a container for a mask or substrate in these apparatuses, and a device manufacturing method using the exposure apparatus and lithography system and devices manufactured with the method.

2. Description of the Related Art

In a lithography process for manufacturing semiconductor devices or the like, an exposure apparatus has been mainly used such as so-called stepper or scanning-stepper, and recently as an exposure light source thereof, a KrF excimer laser is often employed. Furthermore, a lithography system is becoming popular in which such exposure apparatus and a coater-developer (referred to as a “C/D” hereinafter, as the need arises) are connected in-line. That is because, in the lithography process, the process of resist coating, exposure and development is performed and it is necessary to, in any of the steps, prevent dust and so forth from entering the apparatus and to perform the process as efficiently as possible.

FIG. 28 shows a plan view of the arrangement of a lithography system that has been mainly used. The lithography system 300 in FIG. 28 comprises an excimer laser unit 302 as exposure light source such as a KrF excimer laser unit or ArF excimer laser unit, an exposure-apparatus main body 306 with which the excimer laser unit 302 is connected through a guide optical system 304 having at least part of an optical system, for adjusting an optical axis, that is referred to as a beam-matching unit, and a C/D 308 that is connected in-line with the exposure-apparatus main body 306. This lithography system 300 is also referred to as a left-inline because the C/D 308 is disposed on the left of the exposure-apparatus main body 306. On the front end of C/D 308 (left end of the drawing) in FIG. 28, a plurality of wafer containers 310 can be mounted which is transferred by an auto-conveying system moving along the ceiling, referred to as OHV (Over Head Vehicle) or OHT (Over Head Transfer), or an auto-conveying vehicle, referred to as AGV (Automatic Ground Vehicle). As the wafer container 310, an open carrier (“OC” for short hereinafter, as the need arises) or front opening unified pod (a “FOUP” for short hereinafter) is employed. As a container for a mask or reticle (referred to as a “reticle” hereinafter), SMIF (Standard Mechanical Interface) pod or the like is employed. In FIG. 28 a symbol Hw indicates a rail for the OHV.

In the lithography system 300 of FIG. 28, when a container for a reticle is also transported by a OHV, as with a wafer, it is preferable to dispose a housing 312 on a side of the exposure-apparatus main body 306 as id, shown FIG. 29B to disposing it in front of the exposure-apparatus main body 306 as shown in FIG. 29A, the housing 312 having a delivery port where a reticle is passed and received. That is because although in FIG. 29A a rail Hr of an auto-conveying system for a reticle crosses the rail Hw, the rails Hr and Hw in FIG. 29B are parallel to each other not crossing so that the arrangement of the rails is easy.

Meanwhile, the lithography system is rarely disposed alone in a clean room. In an actual factory, a plurality of lithography systems are arranged in a clean room. Furthermore, because the clean room is expensive, it is desirable that the floor area be smaller, and that more lithography systems be efficiently arranged in a confined space.

However, because a lithography system of the above left-inline or a right-inline opposite thereto has a complicated shape in the plan view, arranging a plurality of them in the clean room causes a lot of dead spaces as shown in FIG. 30 and thus the decrease of space efficiency.

It is noted that although in FIG. 30, only left-inline lithography systems are arranged, right-inline and left-inline lithography systems may be so arranged that C/D's thereof are opposite to each other. This case also causes a lot of dead spaces and thus the decrease of space efficiency.

So as to solve such problem, a lithography system called a front-inline is being adopted recently in which the C/D 308 is connected in-line with the front surface of the exposure-apparatus main body 306. This lithography system 400 in FIG. 31 is rectangular in the plan view. When a plurality of lithography systems 400 are arranged in a clean room as shown in FIG. 32, the number of the dead spaces is obviously smaller than in FIG. 30, thereby improving the space efficiency.

In addition, in the front-inline lithography system 400 in FIG. 31, an OHV is also often used for reticles as for wafers. In this case, because the C/D 308 is disposed in front of the exposure-apparatus main body 306, the housing 312 having a delivery port, indicated by a symbol R in FIG. 31, for a reticle container may be disposed behind the exposure-apparatus main body 306 (laser side) so as to arrange the rails Hr, Hw parallel to each other. Incidentally, a hatched area MA in FIG. 31 is a maintenance area of the laser unit 302.

In the front-inline lithography system, a carrying in port is often provided into which an operator manually carries a container containing a wafer or reticle and through which a wafer or reticle is transferred into the unit.

In the front-inline lithography system 400 in FIG. 31, a maintenance area MA is necessary which is a hatched area behind the excimer laser unit 302 and which has a width of about 1 m. Therefore, the distance L1 from the furthest edge of the maintenance area MA to the front surface of the exposure-apparatus main body 306 and thus the distance L2 from the furthest edge of the maintenance area MA to the front surface of the C/D 308 are inadequately long, and the space efficiency is not enough.

In the lithography system 400, also because the size W of the right side protrusion of the laser unit 302 further than the exposure-apparatus main body 306 is larger than the width (usually about 1 m) of each of maintenance areas on both sides of the exposure-apparatus main body 306, the space efficiency is not enough. Needless to say, although it is possible to reduce the size W by bending the guide optical system in a complicated manner, this would cause the increase of optical elements of the guide optical system in number and thus the larger attenuation of the laser energy, and that is not a realistic measure.

In addition, when in the front-inline lithography system, an OHV is used for reticles as for wafers, the rail Hr of an auto-conveying system for a reticle is arranged parallel to the rail Hw as shown in FIG. 31. That is because by avoiding the rails Hw, Hr crossing each other, the arrangement of the rails is easier.

However, in the front-inline lithography system 400 in FIG. 31, because a delivery port 302, indicated by a symbol R, for a reticle container is located in a position reverse to an entrance for wafers, the structure of a reticle-conveying system inside the exposure-apparatus main body 306 becomes complicated, and because the laser unit 302, an illumination optical system associated therewith, etc., are behind the exposure-apparatus main body 306, the design of the reticle-conveying system is restricted.

Additionally, if the exposure-apparatus main body 306 of the lithography system 400 has such a structure that maintenance can be performed from the front surface as well as both sides, C/D needs to be moved so as to make a maintenance area in front of the exposure-apparatus main body. But because such work is difficult, its advantage of being able to perform maintenance from the front cannot be used.

Moreover, in the above, prior art exposure apparatus and lithography system, because there is only one delivery port for a reticle container, the total time for transporting and replacing a reticle is inadequately long. As mentioned above, the restriction on the design of the reticle-transport system results in fewer in-out ports for a reticle container.

It is remarked that when an operator manually carries a reticle container containing a reticle into an exposure apparatus, a sealed-type container having a front lid or the like is employed that may have a label, representing information regarding a reticle therein, attached thereto. The operator may want to carry in the reticle container confirming the content of the label facing him, or to confirm the content of the label from outside the apparatus where the reticle container is stocked.

In such cases, a conveying robot inside the apparatus cannot change the orientation of the reticle container even by rotating the reticle container such that the front lid faces the suitable direction in a position in which to pass and receive a reticle to and from a reticle conveying system for the exposure-apparatus main body, and the lid cannot be opened.

Moreover, usually in a clean room a plurality of exposure apparatuses and lithography systems are arranged that are from different makers and that are of different types. In such a case, because of different specifications of the exposure apparatuses it was difficult to transport to every exposure apparatus a reticle container in a suitable orientation for the exposure apparatus when a ceiling-transport system such as OHT transports reticles each contained in a reticle container.

This invention was made under such circumstances, and a first purpose of this invention is to provide an exposure apparatus and lithography system that can reduce the necessary floor area.

A second purpose of this invention is to provide an exposure apparatus and lithography system that can prevent the structure of a mask-transport system inside the exposure apparatus from becoming complicated, even if using a ceiling-transport system as the mask-transport system transporting a mask from outside the exposure apparatus.

A third purpose of this invention is to provide an exposure apparatus and lithography system in which the advantage of being able to perform maintenance from the front can be effectively used.

A fourth purpose of this invention is to provide an exposure apparatus and lithography system in which a mask can be passed and received smoothly to and from a mask-transport system for the exposure-apparatus main body regardless of the orientation of the mask container at the start of transport by the ceiling-transport system.

A fifth purpose of this invention is to provide a lithography system in which the need for the design change of a mask-transport system inside the exposure apparatus can be diminished and in which the total time for transporting and replacing a mask can be reduced.

A sixth purpose of this invention is to provide a lithography system in which a ceiling-transport system can transport to any of the exposure apparatuses a reticle container in a suitable orientation for the exposure apparatus.

A seventh purpose of this invention is to provide a conveying method that can set the final orientations of a mask container and a substrate container to desirable directions regardless of the orientations during transport.

A eighth purpose of this invention is to provide a device manufacturing method that can improve the productivity of highly integrated devices.

### SUMMARY OF THE INVENTION

According to a first aspect of this invention, there is provided a first exposure apparatus used in a lithography process, said exposure apparatus comprising: an exposure-apparatus main body provided on a floor surface; a laser unit, as an exposure light source, arranged in an area of said floor surface, the width of said area being defined by maintenance areas, on both sides of said exposure-apparatus main body, inclusive.

According to this, because a laser unit is arranged in an area of said floor surface, the width of which is defined by maintenance areas on both sides of the exposure-apparatus main body inclusive, the laser unit is not further out into the maintenance areas than both side surfaces of the exposure-apparatus main body, the maintenance areas having to be kept essentially, and the necessary area of the floor can be reduced.

In this case, if the maintenance of the exposure-apparatus main body can be performed from the side on which the laser unit is disposed, it is desirable that said exposure-apparatus main body and said laser unit be so arranged on said floor surface that maintenance areas of said exposure-apparatus main body and said laser unit overlap each other at least partially. In this case, the necessary area of the floor can be reduced compared with keeping individual maintenance areas of the laser unit and the exposure-apparatus main body.

In this case, it is desirable that said exposure-apparatus main body and said laser unit be so arranged on said floor surface that a whole maintenance area of said laser unit is included in a maintenance area of said exposure-apparatus main body. In this case, the necessary area of the floor can be further reduced.

In the first exposure apparatus according to this invention, it is desirable that a housing of said laser unit be arranged on said floor surface and adjacent to a housing of said exposure-apparatus main body. In this case, the optical path from the laser unit to the exposure-apparatus main body becomes short, thereby decreasing the number of optical elements in the optical path and variation of transmittance, and the management of concentration and maintenance are easy because of a shorter range where gas is to be purged.

In the first exposure apparatus according to this invention, it is desirable from the viewpoint of shortening the optical path from the laser unit to the exposure-apparatus main body that a housing of said laser unit be directly connected to a housing of said exposure-apparatus main body. However, even in this case a guide optical system is necessary which is inside those bodies and which has a certain length.

In the first exposure apparatus according to this invention, said laser unit may be connected through a guide optical system to said exposure-apparatus main body.

In the first exposure apparatus according to this invention, a substrate-processing unit may be able to be connected in-line with a side of said exposure-apparatus main body reverse to said laser unit. In this case, because the substrate-processing unit is able to be connected with the side of the exposure-apparatus main body reverse to the laser unit, the lithography system including the substrate-processing unit is of a so-called front-inline type and almost rectangular in a plan view. Therefore, a plurality of such lithography systems can be arranged in a clean room efficiently compared with the left-inline or right-inline type. Furthermore, because as well as the laser unit, the substrate-processing unit can be disposed so as to have no protrusion further than the side surfaces of the exposure-apparatus main body, the space efficiency of the clean room can be further improved.

In this case, said substrate-processing unit may be able to be connected through an inline-interface portion with said exposure-apparatus main body. In this case, because there is an empty space in front of the exposure-apparatus main body and on a side of the inline-interface portion, maintenance can be performed from the front if the exposure-apparatus main body is of such a type.

In this case, said inline-interface portion may be detachable from said exposure-apparatus main body. In this case, by removing the inline-interface portion, the maintenance area can be expanded to include the area having been occupied by the inline-interface portion, and maintenance can be done more easily.

In the first exposure apparatus according to this invention, if the substrate-processing unit can be connected through an inline-interface portion with the exposure-apparatus main body, it is desirable that said exposure-apparatus main body and said laser unit be so arranged on said floor surface that maintenance areas of said exposure-apparatus main body and said laser unit overlap each other at least partially. In this case, the necessary area of the floor behind the exposure-apparatus main body can be reduced compared with keeping the maintenance area behind it and the maintenance area of the laser unit that are separate. As a result, the maintenance area to the front can be kept with little increase of the necessary area of the floor compared with the prior art front-inline lithography system.

In the first exposure apparatus according to this invention, if the substrate-processing unit can be connected in-line with the side of the exposure-apparatus main body reverse to the laser unit, it is desirable that near the end surface of a side of said exposure-apparatus main body, to which side said substrate-processing unit is connected, a delivery port may be arranged to and from which a mask container containing a mask is transported by a ceiling-transport system that moves along a rail extending on a ceiling opposite to said floor surface. In this case, a mask-transport system can be disposed in front of the exposure-apparatus main body while behind it, the laser unit and an illumination optical system associated therewith are arranged. Accordingly, the mask-transport system can be arranged vertically apart from a substrate-conveying system, and the structure of the mask-transport system can be prevented from becoming complicated when an OHV is adopted as the conveying system for a mask container. As such a mask-transport system, almost the same structure as that of the prior art exposure apparatus can be adopted.

In this case, the mask container may be a container just containing a mask, or a sealed-type container having a lid that can be opened and closed. In this case, because dust and the like can be prevented from entering the mask container, it is possible to set the cleanness degree of the clean room to about class 100 to 1000 and thus to reduce the cost of the clean room.

According to a second aspect of this invention, there is provided a second exposure apparatus used in a lithography process, said exposure apparatus comprising: an exposure-apparatus main body provided on a floor surface; a laser unit as an exposure light source, which is so arranged on said floor surface that a maintenance area of said exposure-apparatus main body and a maintenance area of said laser unit overlap each other at least partially.

According to this, because the exposure-apparatus main body and the laser unit are so arranged on the floor surface that a maintenance area of the exposure-apparatus main body and a maintenance area of the laser unit overlap each other at least partially, the necessary area of the floor can be reduced compared with keeping individual maintenance areas of the laser unit and the exposure-apparatus main body.

In this case, it is desirable that said exposure-apparatus main body and said laser unit be so arranged on said floor surface that a whole maintenance area of said laser unit is included in a maintenance area of said exposure-apparatus main body. In this case, the necessary area of the floor can be reduced most.

In the second exposure apparatus according to this invention, said exposure-apparatus main body and said laser unit may be arranged in-line along a longitudinal direction of said exposure-apparatus main body on said floor surface.

In the second exposure apparatus according to this invention, it is desirable that a housing of said laser unit be arranged on said floor surface and adjacent to a housing of said exposure-apparatus main body. In this case, the optical path from the laser unit to the exposure-apparatus main body becomes short, thereby decreasing the number of optical elements in the optical path and variation of transmittance, and the management of concentration and maintenance are easy because of the shorter range where gas is to be purged.

In the second exposure apparatus according to this invention, it is desirable from the viewpoint of shortening the optical path from the laser unit to the exposure-apparatus main body that a housing of said laser unit be directly connected to a housing of said exposure-apparatus main body. However, even in this case a guide optical system is necessary which is inside those bodies and which has a certain length.

In this case, said laser unit may be so arranged on said floor surface that a longitudinal direction of said laser unit coincides with a longitudinal direction of said exposure-apparatus main body.

In this case, said laser unit may be any of an ArF excimer laser unit having an oscillation wavelength of 193 nm, a F₂ laser unit and a laser plasma unit. In the ArF excimer laser unit, F₂ laser unit, etc., a laser tube (laser resonator) is disposed along the longitudinal direction thereof, which tube is charged with a plurality of noble gases. Accordingly, no reflection optical element is needed which deflects the optical path thereof as in the prior art. Furthermore, an EUV exposure apparatus using a laser plasma unit will have fewer reflection optical elements, and energy decrease of EUV light can be prevented.

In the second exposure apparatus according to this invention, said laser unit may be connected through a guide optical system to said exposure-apparatus main body.

In the first and second exposure apparatuses according to this invention, when the laser unit is connected through a guide optical system to the exposure-apparatus main body, the guide optical system can be disposed above the floor on which the exposure apparatus is provided, without causing any trouble in maintenance. However, said guide optical system may be arranged below a floor surface on which said exposure-apparatus main body is provided. In this case, because there is no guide optical system (obstacle), maintenance can be performed comfortably and easily.

In the first and second exposure apparatuses according to this invention, the laser unit may be a YAG laser unit using a harmonic wave as exposure light or a semiconductor laser (including a fiber amplifier), or may be a unit that emits laser light in a vacuum ultraviolet range or soft X-ray range. In this case, said laser unit may be an excimer laser unit.

According to a third aspect of this invention, there is provided a third exposure apparatus connected in-line with a substrate-processing unit, said exposure apparatus comprising: an exposure-apparatus main body that transfers a pattern of a mask onto a substrate through a projection optical system and to the front surface of which said substrate-processing unit can be connected, said front surface being an end surface in a longitudinal direction of said exposure-apparatus main body, and wherein, in a side of said exposure-apparatus main body, which side is in front of an optical axis of said projection optical system and to which side said substrate-processing unit is connected, a delivery port is arranged into and from which said mask contained in a mask container is loaded and unloaded by a ceiling-transport system that moves along a rail extending on a ceiling opposite to said floor surface on which said exposure-apparatus main body is provided.

According to this, in a side of the exposure apparatus, to which side the substrate-processing unit is connected and which side is in front of the optical axis of the projection optical system, i.e. the front side of the exposure apparatus, a delivery port is provided into and from which a mask contained in a mask container is loaded and unloaded by a ceiling-transport system that moves along a rail extending on a ceiling, the front side being reverse to the back side where an illumination optical system is usually arranged. Therefore, a mask-transport system can be arranged in the front side, which is in front of the optical axis of the projection optical system. Accordingly, the mask-transport system can be arranged vertically apart from a substrate-conveying system in the side, close to the substrate-processing unit, of the exposure apparatus, and the structure of the mask-transport system can be prevented from becoming complicated when a ceiling-transport system is adopted as the conveying system for a mask container from outside the exposure apparatus. As such a mask-transport system, almost the same structure as that of the prior art exposure apparatus can be adopted. Furthermore, when the substrate-processing unit is connected to the front surface of the exposure apparatus, and the same ceiling-transport system for substrates as that of the prior art is used, the rail thereof can be arranged parallel to the rail of the ceiling-transport system for mask containers.

In this case, said exposure-apparatus main body may be able to be connected with an end of an inline-interface portion, another end of which is connected with said substrate-processing unit. In this case, because the substrate-processing unit is connected through an inline-interface portion to the front surface of the exposure apparatus, enough space for maintenance can be kept between the front of the exposure apparatus and the substrate-processing unit. Additionally, if the exposure apparatus has such a structure that maintenance can be performed from the front surface as well as both sides, maintenance can be easily performed from the front, and its advantage of being able to perform maintenance from the front can be effectively used.

In this case, said end of said inline-interface portion may be detachable from said exposure-apparatus main body. In this case, because the end of said inline-interface portion can be easily removed from the exposure-apparatus main body, the area having been occupied by the inline-interface portion can be used as the maintenance area of the exposure apparatus, and maintenance from the front of the exposure apparatus is easier.

In the third exposure apparatuses according to this invention, at least two mask containers that are the same as said mask container may be able to be placed along a rail of said ceiling-transport system in said delivery port. In this case, one or more ceiling-transport systems that moves along the same rail can transport mask containers to and from a plurality of positions in the delivery port, and a plurality of mask containers can stay in the delivery port at the same time. Therefore, by transferring a mask from each mask container onto a mask holding member of the exposure apparatus, the total time for transporting masks can be shortened compared with transporting mask containers one by one from the outside.

In the third exposure apparatus according to this invention, said delivery port may be arranged at a height of about 900 mm from a floor surface. In this case, an operator can manually carry a mask container to and from the delivery port under suitable conditions from the viewpoint of human engineering.

According to a fourth aspect of this invention, there is provided a fourth exposure apparatus comprising: an exposure-apparatus main body that transfers a pattern of a mask onto a substrate; a mask-container storeroom having a carrying-in port, for a mask container, into which said mask contained in a mask container is carried; a transport mechanism that transports said mask container carried in between said carrying-in port and a position in which to deliver a mask to a conveying system of said exposure-apparatus main body side; and an orientation-change unit that is arranged in part of a path of said transport mechanism transporting said mask container and changes the orientation of said mask container.

It is remarked that “part of a path of transporting” means any position in the path from the carrying-in port to the position in which to deliver a mask, inclusive.

According to this, because an orientation-change unit is arranged in part of the path for transport of mask containers by a transport mechanism that transports a mask container carried in between the carrying-in port and a position in which to deliver a mask to a conveying system for the exposure-apparatus main body, when transporting the mask container carried in between the carrying-in port and the delivery position, the orientation-change unit can change the orientation of the mask container to be a predetermined one suitable for passing and receiving the mask in the delivery position. Accordingly, it is easy to deliver the mask in the mask container to the conveying system for the exposure-apparatus main body.

In this case, orientation-change units can be used that have different structures. For example, said orientation-change unit may comprise a turntable on which said mask container is mounted, and a driving mechanism that rotates said turntable. In this case, by mounting the mask container on the turntable and rotating the turntable through a predetermined angle by the driving mechanism, the orientation of the mask container can be changed to be a predetermined one suitable for passing and receiving the mask in the delivery position.

In this case, said orientation-change unit may be arranged on the ceiling of said mask-container storeroom. In this case, the ceiling-transport system mounts a mask container on the turntable. Soon after that, the driving mechanism can change the orientation of the mask container to be a predetermined one if necessary.

Moreover, said turntable may have a kinematic support structure that supports said mask container at a point, line and plane.

When the orientation-change unit comprises the turntable and the driving mechanism that rotates the turntable, the fourth exposure apparatus according to this invention may comprise an orientation-detection mechanism that detects the orientation of said mask container mounted on said turntable, and said driving mechanism may set an angle through which said turntable is to be rotated, based on detection results of said orientation-detection mechanism. In this case, the orientation-detection mechanism detects the orientation of the mask container mounted on the turntable, and the driving mechanism sets an angle through which the turntable is to be rotated, based on detection results of the orientation-detection mechanism. Therefore, even if the orientation of the mask container carried to the carrying-in port is random, the orientation of the mask container can be set to be suitable for passing and receiving the mask in the delivery position. Accordingly, no restriction needs to be set on the orientation of the mask container upon the carrying-in.

In the fourth exposure apparatus according to this invention, said carrying-in port may be a delivery port which is provided on the ceiling of said mask-container storeroom, and to which said mask container is delivered by a ceiling-transport system transporting said mask contained said mask container. Or the carrying-in port may be an in-out port which is provided on a side surface of the mask-container storeroom, and into which an operator manually carries a mask container containing a mask or into which an auto-conveying vehicle such as AGV transports a mask container. In any case, regardless of the orientation of the mask container upon carrying into the carrying-in port, the orientation of the mask container can be changed to be suitable for passing and receiving the mask in the delivery position during transport from the carrying-in port to the delivery position by a transport mechanism.

If the carrying-in port is a delivery port, at least two mask containers that are the same as said mask container may be able to be placed in-line along a rail of said ceiling-transport system in said delivery port. In this case, one or more ceiling-transport systems that moves along the same rail can transport mask containers to and from a plurality of positions in the delivery port, and a plurality of mask containers can stay in the delivery port at the same time. Therefore, by transferring each mask container to the delivery position by the transport mechanism and then the mask onto a mask holding member of the exposure apparatus by the conveying system for the exposure-apparatus main body, the total time for transporting masks can be shortened compared with transporting mask containers one by one from the outside.

In this case, said orientation-change unit may change individually orientations of mask containers that are placed in said delivery port.

According to a fifth aspect of this invention, there is provided a first lithography system comprising: either of the first and second exposure apparatuses according to this invention; a substrate-processing unit that is arranged on a side of, said exposure-apparatus main body, reverse to said laser unit and is connected in-line with said exposure-apparatus main body.

According to this, because the exposure apparatuses can reduce the necessary floor area, the space efficiency can be improved when a plurality of such lithography systems are arranged in a clean room.

In this case, the substrate-processing unit may be a coater (resist coating unit), a developer (development unit), or a coater-developer. In this case, in the lithography process, the process of resist coating, exposure and development can be efficiently performed substantially preventing dust and so forth from entering the apparatus.

According to a sixth aspect of this invention, there is provided a second lithography system used in a clean room comprising: an exposure apparatus that is provided on a floor surface of said clean room and transfers a pattern of a mask onto a substrate through a projection optical system; a substrate-processing unit that is arranged on the front side of said exposure-apparatus main body on said floor surface and is connected in-line with said exposure-apparatus main body, said front side being seen in a longitudinal direction of said exposure-apparatus main body; and a first ceiling-transport system that moves along a first rail extending in a predetermined direction on a ceiling of said clean room, and wherein between an optical axis of said projection optical system and said substrate-processing unit, a delivery port is arranged into and from which said mask contained in a mask container is loaded and unloaded by said first ceiling-transport system.

According to this, between the optical axis of the projection optical system and the substrate-processing unit, that is in the front side of the exposure apparatus, a delivery port is provided into and from which a mask contained in a mask container is loaded and unloaded by a first ceiling-transport system that moves along a first rail, the front side being reverse to the back side where an illumination optical system is usually arranged. Therefore, a mask-transport system can be arranged in the front side, which is in front of the optical axis of the projection optical system. Accordingly, the mask-transport system can be arranged vertically apart from a substrate-conveying system in the side, close to the substrate-processing unit, of the exposure apparatus, and the structure of the mask-transport system can be prevented from becoming complicated when a ceiling-transport system is adopted as the conveying system for a mask container from outside the exposure apparatus. As such a mask-transport system, almost the same structure as that of the prior art exposure apparatus can be adopted.

In this case, the lithography system may further comprise: a second ceiling-transport system that moves along a second rail extending parallel to said first rail on said ceiling and that transports said substrate contained in a substrate container from and to said substrate-processing unit. In this case, because the second rail of the second ceiling-transport system that transports a substrate contained in a substrate container from and to the substrate-processing unit is arranged parallel to the first rail on the ceiling, the arranging of the rails on the ceiling is easy.

In this case, said first and second rails may extend in a direction substantially perpendicular to the longitudinal direction of said exposure apparatus.

In this case, at least two mask containers that are the same as said mask container may be able to be placed in-line along said first rail in said delivery port. In this case, one or more ceiling-transport systems that moves along the first rail can transport mask containers to and from a plurality of positions in the delivery port, and a plurality of mask containers can stay in the delivery port at the same time. Therefore, by transferring a mask from each mask container onto a mask holding member of the exposure apparatus, the total time for transporting masks can be shortened compared with transporting mask containers one by one from the outside.

In the second lithography system according to this invention, it is desirable that maintenance of said exposure apparatus be able to be performed from at least both sides thereof. In this case, enough maintenance area can be kept on both sides of the exposure apparatus.

The second lithography system according to this invention may further comprise an inline-interface portion that is arranged between said exposure apparatus and said substrate-processing unit and that connects the both. In this case, because there is an empty space in front of the exposure-apparatus main body and on a side of the inline-interface portion, maintenance can be easily performed from the front, using the empty space as the maintenance area if the exposure-apparatus main body has such a structure.

In this case, the second lithography system may further comprise: a mask-transport-system housing that is arranged parallel to said inline-interface portion and has said mask-transport system therein, and said delivery port may be arranged on the ceiling of a mask-transport-system housing. That is, a housing that is detachable from the exposure apparatus and that has a delivery port for masks containers may be disposed in the empty space.

In this case, said first rail may extend in a direction substantially perpendicular to the longitudinal direction of said exposure apparatus, and at least two mask containers that are the same as said mask container may be able to be placed in-line along said first rail in said delivery port. In this case, one or more ceiling-transport systems that moves along the first rail can transport mask containers to and from a plurality of positions in the delivery port, and a plurality of mask containers can stay in the delivery port at the same time. Therefore, by transferring a mask from each mask container onto a mask holding member of the exposure apparatus, the total time for transporting masks can be shortened compared with transporting mask containers one by one from the outside.

In the second lithography system according to this invention, which comprises an inline-interface portion and the mask-transport-system housing arranged parallel to the inline-interface portion, one side of said mask-transport-system housing may be in the substantially same plane as one side of said exposure apparatus is, and a in-out port for said mask container may be provided in said one side of said mask-transport-system housing. In this case, by laying the rail of an auto-conveying vehicle such as AGV on the floor along a side surface of the exposure apparatus, the auto-conveying vehicle can carry in and out a mask container containing a mask through the in-out port provided on the one side of the mask-transport-system housing. It is remarked that the mask container may be manually carried in and out.

The second lithography system according to this invention, which comprises an inline-interface portion and the mask-transport-system housing arranged parallel to the inline-interface portion, may further comprise: a substrate-container-extension housing that is arranged adjacent to said mask-transport-system housing and parallel to said inline-interface portion and has an extension port for a substrate container containing said substrate. In this case, by arranging the mask-transport-system housing and substrate-container-extension housing in an empty space on a side of the inline-interface portion, the empty space can be fully used.

In this case, the second lithography system may be a lithography system wherein one side of said substrate-container-extension housing is in the substantially same plane as one side of said exposure apparatus and one side of said mask-transport-system housing are, wherein an extension port for said substrate container is provided in said one side of said substrate-container-extension housing, and wherein an in-out port for said mask container is provided in said one side of said mask-transport-system housing. In this case, by laying the rail of an auto-conveying vehicle such as AGV on the floor along a side surface of the exposure apparatus, the auto-conveying vehicle can carry in and out a substrate container through the extension port, for the substrate container, provided on the one side of the substrate-container-extension housing, and such an auto-conveying vehicle can carry in and out a mask container containing a mask through the in-out port provided on the one side of the mask-transport-system housing. It is remarked that both the auto-conveying vehicle for a mask container and the auto-conveying vehicle for a substrate container may use the same rail.

In this case, it is desirable that said extension port and said in-out port be arranged at the same predetermined height from a floor surface. In this case, it is preferable that the extension port and in-out port are arranged at a height of about 900 mm from a floor surface, which height is suitable from the viewpoint of human engineering when manually carrying in and out a substrate container or mask container.

The second lithography system may be a lithography system comprising an inline-interface portion and the mask-transport-system housing arranged parallel to the inline-interface portion, wherein said mask-transport system inside said mask-transport-system housing transports said mask container that was carried in by said first ceiling-transport system between said delivery port and said position in which to deliver a mask to a conveying system of said exposure apparatus side, and further comprising: an orientation-change unit that changes the orientation of said mask container to be suitable to deliver a mask to said conveying system of said exposure apparatus side in said delivery position before the transport of said mask container to said delivery position.

In this case, the first ceiling-transport system carries a mask container containing a mask into the delivery port provided on the ceiling of the mask-transport-system housing, and the mask-transport system transports the mask container carried in from the delivery port to the position in which to deliver a mask to a conveying system of said exposure apparatus side. And before the transport of the mask container to the delivery position, i.e. during the first ceiling-transport system transporting to the delivery port or during the mask-transport system inside the mask-transport-system housing transporting from the delivery port to the position in which to deliver a mask to a conveying system of said exposure apparatus side, the orientation-change unit changes the orientation of the mask container to be suitable to deliver a mask to the conveying system of the exposure apparatus side in the delivery position. Therefore, regardless of the orientation of the mask container at the start of transport by the first ceiling-transport system, the orientation of the mask container can be changed to be suitable for passing and receiving the mask in the delivery position.

In this case, said orientation-change unit may change the orientation of said mask container during transport by said first ceiling-transport system. Or said orientation-change unit may change the orientation of said mask container while said mask is transported by a conveying system in said mask-transport-system housing.

In the second lithography system according to this invention, said mask-transport-system housing may be detachable. In this case, because the mask-transport-system housing can be easily removed from the exposure-apparatus main body, the area having been occupied by the mask-transport-system housing can be used as the maintenance area of the exposure apparatus if the exposure apparatus has a structure with which maintenance is possible from the front as well as both the sides, and maintenance from the front of the exposure apparatus is even easier.

The second lithography system according to this invention, wherein the exposure apparatus and substrate-processing unit are connected through the inline-interface portion, may further comprise a substrate-container-extension housing that is arranged parallel to said inline-interface portion and has an extension port for a substrate container containing said substrate. That is, the substrate-container-extension housing attachable to the exposure apparatus may be disposed in the empty space.

In this case, the second lithography system may be a lithography system, wherein one side of said substrate-container-extension housing is in the substantially same plane as one side of said exposure apparatus is, and wherein an extension port for said substrate container is provided in said one side of said substrate-container-extension housing. In this case, by laying the rail of an auto-conveying vehicle such as AGV on the floor along a side surface of the exposure apparatus, the auto-conveying vehicle can carry in and out a substrate container through the extension port, for the substrate container, provided on the one side of the substrate-container-extension housing. It is noted that the substrate container may be manually carried in and out using a manual vehicle.

In this case, an in-out port for said mask container may be provided on said one side of said exposure apparatus. In this case, a substrate container and a mask container can be carried in and out through the extension port and the in-out port respectively, using auto-conveying vehicles moving on the same rail.

In this case, it is desirable that said extension port and said in-out port be arranged at the same predetermined height from a floor surface. In this case, it is preferable that the extension port and in-out port are arranged at a height of about 900 mm from a floor surface, which height is suitable from the viewpoint of human engineering when manually carrying in and out a substrate container or mask container.

In the second lithography system according to this invention, when the substrate-container-extension housing is arranged parallel to the inline-interface portion, said substrate-container-extension housing may be detachable. In this case, because the substrate-container-extension housing can be easily removed, maintenance from the front of the exposure apparatus is easier for the same reason as the above.

In the second lithography system according to this invention, said inline-interface portion may be detachable. In this case, because the inline-interface portion can be easily removed, the area having been occupied by the inline-interface portion can be used as the maintenance area of the exposure apparatus if the exposure apparatus has a structure with which maintenance is possible from the front as well as both the sides, and maintenance from the front of the exposure apparatus is even easier.

According to a seventh aspect of this invention, there is provided a third lithography system comprising: an exposure apparatus that is provided on a floor surface of said clean room and transfers a pattern of a mask onto a substrate through a projection optical system; a substrate-processing unit that is connected in-line with said exposure-apparatus main body; and a first ceiling-transport system that moves along a first rail extending in a predetermined direction on a ceiling of said clean room, and wherein below said first rail, a delivery port is arranged into and from which said mask contained in a mask container is loaded and unloaded by said first ceiling-transport system, and on which at least two mask containers can be placed along said first rail.

According to this, because the first ceiling-transport system that moves along the first rail on the ceiling of said clean room transports a mask contained in a mask container, and below the first rail, a delivery port is arranged on which at least two mask containers can be placed along the first rail, one or more first ceiling-transport systems that moves along the first rail can transport mask containers to and from a plurality of positions in the delivery port, and a plurality of mask containers can stay in the delivery port at the same time. Therefore, by transferring a mask from each mask container onto a mask holding member of the exposure apparatus, the total time (including the time for replacement) for transporting masks can be shortened compared with transporting mask containers one by one from the outside.

In this case, the second lithography system may further comprise: a second ceiling-transport system that moves along a second rail extending parallel to said first rail on said ceiling and transports said substrate contained in a substrate container from and to said substrate-processing unit. In this case, because the first and second rails are arranged parallel to each other on the ceiling, the laying of rails is easy. Moreover, in a side of the exposure apparatus, to which side the substrate-processing unit is connected and which side is in front of the optical axis of the projection optical system, i.e. the front side of the exposure apparatus, a delivery port is provided, the front side being reverse to the back side where an illumination optical system is usually arranged. Therefore, a mask-transport system can be arranged in the front side, which is in front of the optical axis of the projection optical system, and for the mask-transport system, almost the same structure as that of the prior art exposure apparatus can be adopted.

In the third lithography system according to this invention, said delivery port may be provided in said exposure apparatus.

The third lithography system according to this invention may be a lithography system further comprising: a mask-transport-system housing in which a conveying system for a mask contained said mask container is provided, and wherein said delivery port is provided in said mask-transport-system housing. In this case, the third lithography system may be a lithography system, wherein said mask-transport system inside said mask-transport-system housing transports said mask container that was carried in by said first ceiling-transport system from said delivery port to said position in which to deliver a mask to a conveying system of said exposure apparatus side, further comprising: an orientation-change unit that changes the orientation of said mask container to be suitable to deliver a mask to said conveying system of said exposure apparatus side in said delivery position before the transport of said mask container to said delivery position. In this case, the first ceiling-transport system carries a mask container containing a mask into the delivery port provided on the ceiling of the mask-transport-system housing, and the mask-transport system transports the mask container carried in from the delivery port to the position in which to deliver a mask to a conveying system of said exposure apparatus side. And before the transport of the mask container to the delivery position, i.e. during the first ceiling-transport system transporting to the delivery port or during the mask-transport system inside the mask-transport-system housing transporting from the delivery port to the position in which to deliver a mask to a conveying system of said exposure apparatus side, the orientation-change unit changes the orientation of the mask container to be suitable to deliver a mask to the conveying system of the exposure apparatus side in the delivery position. Therefore, regardless of the orientation of the mask container at the start of transport by the first ceiling-transport system, the orientation of the mask container can be changed to be suitable for passing and receiving the mask in the delivery position.

In this case, said orientation-change unit may change the orientation of said mask container during transport by said first ceiling-transport system, or said orientation-change unit may change the orientation of said mask container while said mask is transported by a conveying system in said mask-transport-system housing.

In the second and third lithography systems according to this invention, said delivery port may be arranged at a height of about 900 mm from a floor surface. In this case, an operator can manually load and unload a mask container under suitable conditions from the viewpoint of human engineering.

In the second and third lithography systems according to this invention, said substrate container may be a sealed-type container having a lid that can be opened and closed. In this case, because dust and the like can be prevented from entering the substrate container, it is possible to set the cleanness degree of the clean room to about class 100 to 1000 and thus to reduce the cost of the clean room.

In the second and third lithography systems according to this invention, it is desirable that said mask container be a sealed-type container having a lid that can be opened and closed. In this case, because dust and the like can be prevented from entering the mask container, it is possible to set the cleanness degree of the clean room to about class 100 to 1000 and thus to reduce the cost of the clean room.

In this case, said mask container may be a bottom-open-type and sealed-type container.

In the second and third lithography systems according to this invention, said exposure apparatus may have an ultraviolet pulse laser light source as the exposure light source.

In the second and third lithography systems according to this invention, the substrate-processing unit may be a coater (resist coating unit), a developer (development unit), or a coater-developer. In this case, in the lithography process, the process of resist coating, exposure and development can be efficiently performed substantially preventing dust and so forth from entering the apparatus.

According to an eighth aspect of this invention, there is provided a fourth lithography system used in a clean room comprising: an exposure apparatus that is provided on a floor surface of said clean room and transfers a pattern of a mask onto a substrate through a projection optical system; a ceiling-transport system that moves along a rail extending on the ceiling of said clean room and transports said mask contained in a mask container; a mask-container storeroom that has a delivery port into and from which said mask contained in said mask container is loaded and unloaded by said ceiling-transport system on the ceiling thereof; a transport mechanism that transports said mask container carried in between said delivery port and said position in which to deliver a mask to a conveying system of said exposure apparatus side; and an orientation-change mechanism that changes the orientation of said mask container to be suitable to deliver a mask to said conveying system of said exposure apparatus side in said delivery position before the transport of said mask container to said delivery position.

According to this, the ceiling-transport system that moves along a rail extending on the ceiling of the clean room carries a mask container containing a mask into the delivery port provided on the ceiling of the mask-container storeroom, and the mask-transport mechanism transports the mask container carried in from the delivery port to the position in which to deliver a mask to a conveying system of said exposure apparatus side. And before the transport of the mask container to the delivery position, i.e. during the ceiling-transport system transporting to the delivery port or during the mask-transport mechanism transporting from the delivery port to the position in which to deliver a mask to a conveying system of said exposure apparatus side, the orientation-change mechanism changes the orientation of the mask container to be suitable to deliver a mask to the conveying system of the exposure apparatus side in the delivery position. Therefore, regardless of the orientation of the mask container at the start of transport by the ceiling-transport system, the orientation of the mask container can be changed to be suitable for passing and receiving the mask in the delivery position.

In this case, said orientation-change mechanism may change the orientation of said mask container during transport by said ceiling-transport system, or said orientation-change mechanism may change the orientation of said mask container during transport by said transport mechanism. In the latter, said orientation-change mechanism is arranged in part of a path of said transport mechanism transporting said mask container.

It is remarked that “part of a path of transporting” means any position in the path from the carrying-in port to the position in which to deliver a mask, inclusive.

In this case, orientation-change mechanisms can be used that have different structures. For example, said orientation-change mechanism may comprise a turntable on which said mask container is mounted, and a driving mechanism that rotates said turntable. In this case, by mounting the mask container on the turntable and rotating the turntable through a predetermined angle by the driving mechanism, the orientation of the mask container can be changed to be a predetermined one suitable for passing and receiving the mask in the delivery position.

In this case, the fourth lithography system may be a lithography system wherein the exposure apparatus further comprises an orientation-detection mechanism that detects the orientation of said mask container mounted on said turntable, and wherein said driving mechanism sets an angle through which said turntable is to be rotated, based on detection results of said orientation-detection mechanism. In this case, the orientation-detection mechanism detects the orientation of the mask container mounted on the turntable, and the driving mechanism sets an angle through which the turntable is to be rotated, based on detection results of the orientation-detection mechanism. Therefore, even if the orientation of the mask container carried to the carrying-in port is random, the orientation of the mask container can be set to be suitable for passing and receiving the mask in the delivery position. Accordingly, no restriction needs to be set on the orientation of the mask container upon the carrying-in.

In the fourth lithography system according to this invention, said orientation-change mechanism may be arranged in said delivery port. In this case, the ceiling-transport system mounts a mask container on the turntable. Soon after that, the driving mechanism can change the orientation of the mask container to be a predetermined one if necessary.

According to a ninth aspect of this invention, there is provided a fifth lithography system used in a clean room comprising: a plurality of exposure apparatuses that are provided on a floor surface of said clean room and transfer a pattern of a mask onto a substrate through a projection optical system; a ceiling-transport system that moves along a rail extending on the ceiling of said clean room and transports said mask contained in a mask container; and an orientation-setting mechanism that is provided on said ceiling-transport system, and, before carrying into each of said exposure apparatuses, sets the orientation of said mask container to be suitable for said exposure apparatus.

According to this, because, on the ceiling-transport system, an orientation-setting mechanism is provided that, before carrying into each of the exposure apparatuses, sets the orientation of a mask container to be suitable for the exposure apparatus, the same ceiling-transport system can transport mask containers even if each of the plurality of exposure apparatuses has a respective orientation in which to carry in a mask container. Therefore, even if a plurality of exposure apparatuses which are from different makers and which have different specifications are arranged in the same clean room, it is possible to transport a mask contained in a mask container to each of the exposure apparatuses by the same ceiling-transport system, setting the orientation of the mask container to be suitable for the exposure apparatus.

It is remarked that there are several method with which to set the orientation of a mask container to be suitable for each exposure apparatus. For example, said orientation-setting mechanism may set the orientation of said mask container based on information, stored beforehand, concerning orientation suitable for each exposure apparatus, or said orientation-setting mechanism may set the orientation of said mask container according to an instruction from a host unit. In these cases, the orientation-setting mechanism may set the orientation of a mask container based on information about relations between an orientation upon transport by the ceiling-transport system and an orientation suitable for each exposure apparatus, or the host unit may give a suitable instructing value based on such information. In either case, the information about relations between an orientation of a mask container upon transport by the ceiling-transport system and an orientation of the mask container suitable for each exposure apparatus needs to be set beforehand.

In the fifth lithography system according to this invention, said orientation-setting mechanism may set the orientation of said mask container based on communication results with each of said exposure apparatus. In this case, because the orientation-setting mechanism sets the orientation of a mask container based on communication results with each exposure apparatus, it is possible to transport the mask container to each of the exposure apparatuses, setting the orientation of the mask container to be suitable for the exposure apparatus regardless of the orientation of the mask container upon transport by the ceiling-transport system.

According to a tenth aspect of this invention, there is provided a transport method with which to transport a container containing an object to be conveyed from a first position to a second position where said object to be conveyed is delivered to an exposure-apparatus main body side, wherein during said transport, the orientation of said mask container is set according to orientation in which to deliver in said second position.

According to this, while transporting a container containing an object to be conveyed from a first position to a second position where the object to be conveyed is delivered to an exposure-apparatus main body side, the orientation of the mask container is set according to orientation in which to deliver in the second position. Therefore, the orientation of the container has been set to an orientation suitable to pass and receive, before the object to be conveyed is delivered to an exposure-apparatus main body side in the second position, regardless of the orientation of the container in the first position. The first position may be any position in the path of the ceiling-transport system transporting a container, or any position in the room into which the container is carried.

In this case, said object to be conveyed may be a mask having a pattern formed thereon, or said object to be conveyed may be a substrate subject to exposure onto which a predetermined pattern is transferred. That is, the container may be a mask container to contain a mask or a substrate container to contain a substrate.

Moreover, by performing exposure using an exposure apparatus according to this invention in a lithography process, patterns can be accurately formed on a substrate, and it is possible to manufacture highly-integrated micro devices with high yield and improved productivity. Furthermore, by using a pulse laser light source such as an ArF excimer laser unit or F₂ laser unit in a lithography system of this invention, exposure with high resolving power is possible, and the process of resist coating, exposure and development can be efficiently performed substantially preventing dust and so forth from entering the apparatus. Accordingly, it is possible to manufacture highly-integrated micro devices with high yield and improved productivity. Therefore, according to another aspect of this invention, there are provided a device manufacturing method using an exposure apparatus or lithography system of this invention, and devices manufactured using the manufacturing method.

### BRIEF DESCRIPTION OF THE DRAWINGS

FIG. 1 is a schematic, oblique view showing a first embodiment of a lithography system including an exposure apparatus according to this invention;

FIG. 2 is a plan view showing a clean room in which the lithography system in FIG. 1 is provided;

FIG. 3 is a right side view of the lithography system in FIG. 1;

FIG. 4A is a cross-sectional view, taken in the lateral direction, of a reticle port housing according to the first embodiment;

FIG. 4B is a cross-sectional view of a reticle port housing in FIG. 4A, taken in the longitudinal direction;

FIG. 5A is a cross-sectional view of a reticle carrier, taken in the longitudinal direction;

FIG. 5B is a view of the reticle carrier, in FIG. 5A, having the lid thereof removed;

FIG. 6 is a cross-sectional view of an exposure-apparatus main body and a FOUP extension housing connected thereto, taken in the lateral direction with part of those being not shown;

FIG. 7 is a plan view of a layout of a plurality of such lithography systems in FIG. 1;

FIG. 8 is a plan view of a modified example of the lithography system of the first embodiment;

FIG. 9 is a schematic, oblique view of a lithography system according to a second embodiment of this invention;

FIG. 10 is a plan view of the lithography system in FIG. 9;

FIG. 11 is a side view of the lithography system in FIG. 9;

FIG. 12 is a schematic, oblique view of a lithography system according to a third embodiment of this invention;

FIG. 13 is a plan view of the lithography system in FIG. 12;

FIG. 14 is a side view of the lithography system in FIG. 12;

FIG. 15A is a plan view of a lithography system according to a fourth embodiment of this invention;

FIG. 15B is a front view of the lithography system in FIG. 15A;

FIG. 16A is a plan view of a lithography system according to a fifth embodiment of this invention;

FIG. 16B is a front view of the lithography system in FIG. 16A;

FIG. 17 is a schematic, oblique view of a lithography system according to a sixth embodiment of this invention;

FIG. 18 is a right side view of the lithography system in FIG. 17;

FIG. 19A is a cross-sectional view, taken in the lateral direction, of a reticle port housing according to the sixth embodiment;

FIG. 19B is a cross-sectional view of a reticle port housing in FIG. 19A, taken in the longitudinal direction;

FIG. 20 is a oblique view of an orientation-change unit on a larger scale;

FIG. 21A shows a reticle carrier mounted on the turntable of the orientation-change unit, which carrier has been carried in by a robot arm;

FIG. 21B shows a state where the turntable has been turned through 180 degrees relative to the state in FIG. 21A;

FIG. 22 is a oblique view of an orientation-change unit having an orientation-detection mechanism;

FIG. 23A is a schematic plan view of a reticle carrier suitable for the orientation-change unit in FIG. 22;

FIG. 23B is a bottom view of the reticle carrier in FIG. 23A;

FIG. 24 is a schematic view showing a ceiling-transport system comprising an orientation-change mechanism;

FIG. 25 is a schematic view showing an arrangement of lithography systems in a clean room where the ceiling-transport system in FIG. 24 is arranged;

FIG. 26 is a flow chart for explaining a device manufacturing method according to this invention;

FIG. 27 is a flow chart showing a process of step 204 of FIG. 26;

FIG. 28 is a plan view of a left-inline lithography system according to the prior art;

FIG. 29A is a plan view showing a case where the lithography system of FIG. 28 adopts a ceiling-transport system also for reticles;

FIG. 29B is a plan view showing another case where the lithography system of FIG. 28 adopts a ceiling-transport system also for reticles;

FIG. 30 is a plan view of a layout of a plurality of such lithography systems in FIG. 28;

FIG. 31 is a plan view of a front-inline lithography system according to the prior art; and

FIG. 32 is a plan view of a layout of a plurality of such lithography systems in FIG. 31.

### DESCRIPTION OF THE PREFERRED EMBODIMENTS

<<A First Embodiment>>

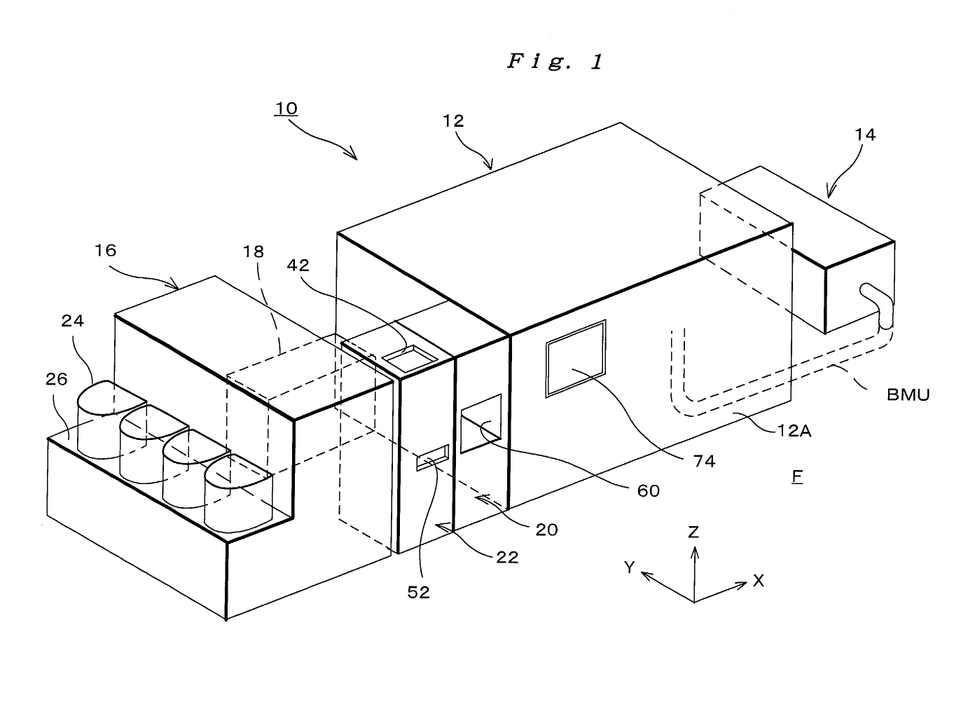

A first embodiment of the present invention will be described below with reference to FIGS. 1 to 6.

FIG. 1 shows the schematic, oblique view of a lithography system of the first embodiment including an exposure apparatus according to this invention. The lithography system 10 is provided in a clean room having a cleanness degree of class 100 through 1,000. The lithography system 10 comprises an exposure-apparatus main body 12 disposed on a floor surface F of the clean room, a laser light unit 14 that serves as an exposure light source and that is disposed on the back side (+X-side), in the longitudinal direction (an X-direction in FIG. 1), of the exposure-apparatus main body 12 and apart from the exposure-apparatus main body 12 by a predetermined distance on the floor surface F, a C/D 16 that serves as a substrate process unit and that is disposed on the front side (−X-side), in the longitudinal direction, of the exposure-apparatus main body 12 and apart from the exposure-apparatus main body 12 by a predetermined distance, an inline-interface portion 18 that connects the exposure-apparatus main body 12 in-line with C/D 16, a FOUP extension housing 20 that serves as a substrate-container-extension housing and that is disposed parallel to the inline-interface portion 18 and adjacent to the body (environmental chamber) 12A of exposure-apparatus main body 12, a reticle port housing 22 that serves as a mask-transport-system housing and that is disposed parallel to inline-interface portion 18 and adjacent to the FOUP extension housing 20, a guide optical system (hereafter, referred to as a “beam-matching unit” for the sake of convenience) BMU that optically connects exposure-apparatus main body 12 and laser unit 14 and that includes an optical system for adjusting an optical axis, which system is referred to as a beam-matching-unit, and the like.

In this embodiment, the respective outer shape sizes of exposure-apparatus main body 12, laser unit 14 and C/D 16 are the same as those of the example of the prior art already described.

As laser unit 14, KrF excimer laser that emits far ultraviolet pulse light of oscillation wavelength 248 nm, ArF excimer laser that emits vacuum ultraviolet pulse light of oscillation wavelength 193 nm, F₂ laser that emits vacuum ultraviolet pulse light of oscillation wavelength 157 nm or the like is used.

In addition, as exposure-apparatus main body 12, an exposure apparatus of the step-and-repeat type or the step-and-scan type is used to transfer a pattern of a reticle onto a wafer, and the exposure-apparatus main body 12, the laser unit 14 and the beam-matching unit BMU compose an exposure apparatus according to this invention. The exposure-apparatus main body 12 has an arrangement in which maintenance can be performed from any direction, before, behind, right, and left.

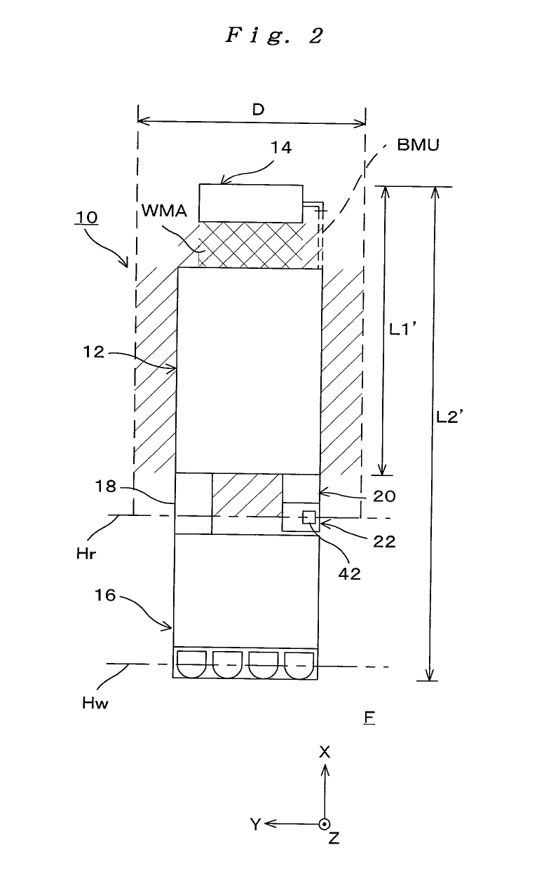

FIG. 2 shows a plan view of a clean room provided with the lithography system 10. In FIG. 2, the hatched area of the floor surface F shows the maintenance area of the exposure-apparatus main body 12 and a cross-hatched area WMA shows the maintenance area of both the exposure-apparatus main body 12 and the laser unit 14.

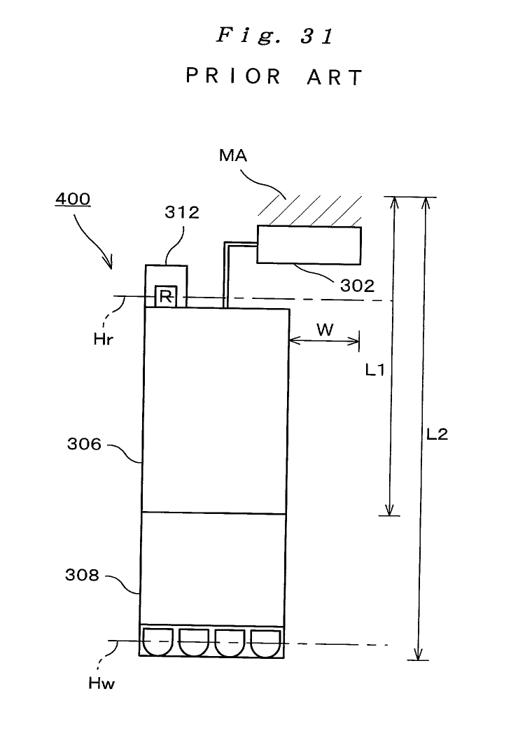

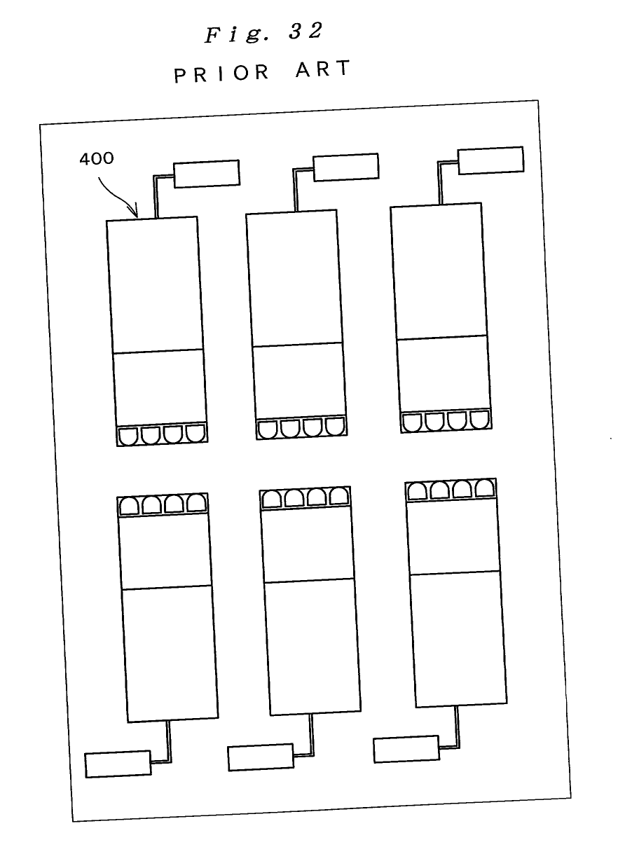

As shown in FIG. 2, in this embodiment, the laser unit 14 is disposed within an area of width D on the floor surface F (an area surrounded by two dotted lines in FIG. 2), the width D being defined by maintenance areas, on both sides (in the Y-direction) of the exposure-apparatus main body 12, inclusive. The laser unit 14 has no protrusion into the maintenance areas on both sides of the exposure-apparatus main body 12. Therefore, by using the lithography system 10 of this embodiment and the exposure apparatus contained therein, necessary width of the floor surface F can be reduced compared with the lithography system shown in FIG. 31.

In addition, as seen by comparing a length L1′ in FIG. 2 and a length L1 in FIG. 31 (the example of the prior art), the necessary size in the longitudinal direction of the floor surface F (the longitudinal direction of the exposure-apparatus main body) is smaller in this embodiment by the size of maintenance area of the laser unit 14.

Note that the maintenance areas on both sides of the exposure-apparatus main body should be kept essentially.

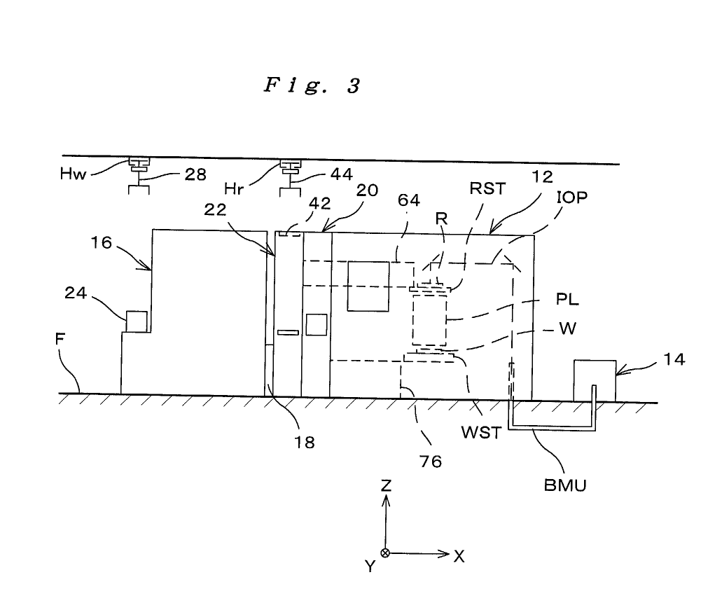

Most part of the beam-matching unit BMU, as shown in FIG. 3 illustrating the right side view of the lithography system 10, is arranged below the floor surface F on which the exposure-apparatus main body is provided. Usually, the floor of a clean room is formed by a large number of columns planted predetermined distances apart from each other and mesh-shaped floor members placed in the shape of a matrix on the top of the columns. Therefore, by removing several of the floor members and columns attached thereto, the beam-matching unit BMU is easily installed under the floor.

Referring back to FIG. 1, the inline-interface portion 18 comprises a housing and a wafer conveying system (not shown) contained in the housing. The wafer conveying system conveys wafers between C/D 16 and the exposure-apparatus main body 12. In this embodiment, the inline-interface portion 18 is made to be attachable. That is, as the inline-interface portion 18, one constructed to be attachable is adopted.

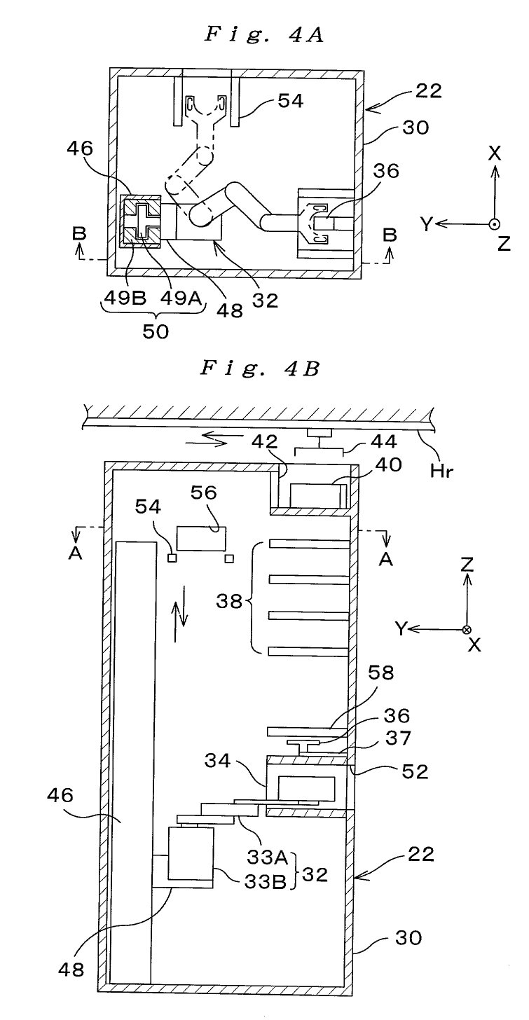

FIG. 4A shows a schematic, lateral cross-section view of the reticle port housing 22, and FIG. 4B shows a schematic, longitudinal cross-section view of the reticle port housing 22. FIG. 4A shows the cross-section taken along A-A line in FIG. 4B, and FIG. 4B shows the cross-section along B-B line in FIG. 4A.

In the below, the reticle port housing 22 will be described with reference to FIGS. 4A and 4B.

As the reticle port housing 22, a housing is used that is made to be attachable and connectable to the FOUP extension housing 20. The reticle port housing 22 comprises a chamber 30 as the body thereof, a horizontal, articulated robot (scalar robot) 32 as a mask (reticle) conveying system disposed at the end in the +Y direction inside the chamber 30, a carrier mount 34 provided on the side wall in the −Y direction inside the chamber 30 and at a height of about 900 mm from the floor surface, an ID reader 36 provided above the carrier mount 34, a carrier stock portion 38 provided above the ID reader 34 and the like.

Near the corner, in the −Y direction and in the −X direction, of the ceiling of the chamber 30, an delivery port 42 is provided through which a reticle carrier 40, a mask container, containing a reticle is carried in and out by a OHV 44 described later. On the ceiling almost straight above the delivery port 42, a guide rail Hr serving as the rail of the OHV 44 as a first ceiling-transport system to convey the reticle carrier 40 containing a reticle extends in the Y-direction (refer to FIG. 2), the rail of OHV 44 being also referred to as a first track.

The scalar robot 32, as shown in FIGS. 4A and 4B, comprises an expandable arm 33A that is rotatable in the X-Y plane and a driving portion 33B to drive the arm 33A. The scalar robot 32 is mounted on the upper surface of a supporting member 48 moving up and down along a support guide 46 that is provided in the end in the +Y direction inside the chamber 30 and that extends upwards from the floor surface. Accordingly, the arm 33A of the scalar robot 32 can expand and contract, rotate in the X-Y plane, and also move up and down. Note that the up/down movement of the supporting member 48 is performed by a linear actuator 50 (refer to FIG. 4A) composed of a mover 49A integrated with the supporting member 48 and a stator 49B extending in the Z-direction inside the supporting guide 46.

In the side wall in the −Y direction inside the chamber 30, an in-out port 52 for the reticle carrier and the carrier mount 34 is made. Through the in-out port 52, an operator loads and unloads the reticle carrier 40 onto and from the carrier mount 34.

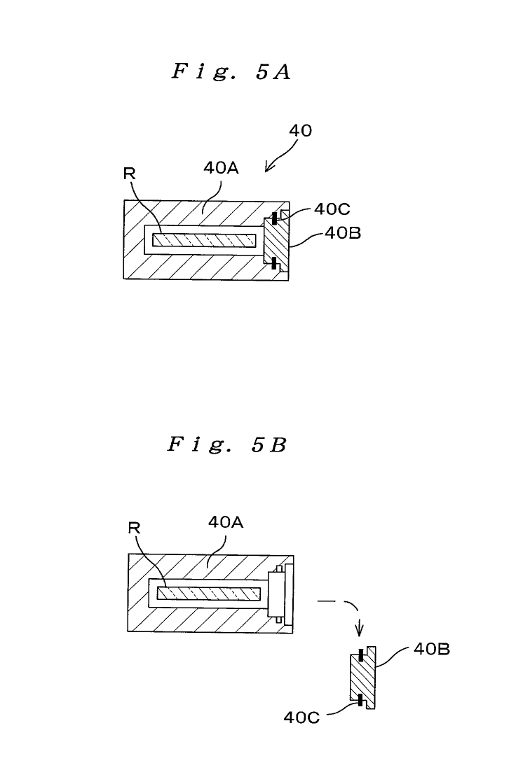

In this embodiment, as the reticle carrier 40, as shown in FIG. 5A, a closed-type reticle carrier that comprises a container main body 40A and lid 40B and that contains a reticle R is used. The lid 40B of the reticle carrier 40 is fixed to the container main body 40A by a lock mechanism 40C, and by unfastening the lock mechanism 40C, the lid 40B can be removed from the container main body 40A as shown in FIG. 5B. An open-close mechanism that is provided inside the FOUP extension housing 20 adjacent to the reticle port housing 22 and that is referred to as an opener (not shown) performs unfastening of the lock mechanism 40C and removal of the lid 40B.

This will be described in more detail in the below. Near the upper end of the side wall in the +X direction of the chamber 30, as shown in FIG. 4B, a rack 54 composed of a pair of supporting members that support both the ends of the bottom of the reticle carrier 40 is fixed perpendicular to the side wall. A rectangular opening 56 just larger than the lid 40B is made in the sidewall of the chamber 30, which opening 56 faces the lid 40B when the reticle carrier 40 is mounted on the rack 54. And an open-close member that covers and closes the opening 56 is provided in the open-close mechanism. In a usual state (the state of the reticle carrier not being set), the open-close member is fitted and fasten to the opening 56 so that the inside of the FOUP extension housing 20, which inside is behind the side wall of the chamber 30, is not left open with respect to the reticle port housing 22.

On the other hand, the opening and closing of the lid 40B of the reticle carrier 40 is performed in the following manner. After the scalar robot 32 carries the reticle carrier 40 on the arm 33A from the carrier mount 34 or the carrier stock portion 38 onto the rack 54, the reticle carrier 40 is pushed against the side wall of the chamber 30. At this time, the lid 40B is pushed against the open-close member. Next, the open-close mechanism operates a fix-and-unlock mechanism provided in the open-close member, the fix-and-unlock mechanism fixing the lid to the open-close member by vacuum chuck or mechanical connection and unfastening the lock mechanism 40C provided in the lid 40B. By this, the lock mechanism 40C of the reticle carrier 40 is unfastened, and the lid 40B and the open-close member, which are fixed to each other, are conveyed to a stock area inside the FOUP extension housing 20. In this manner, the opening sequence of the lid 40B is performed. The closing sequence of the lid 40B is the reverse of the opening sequence. Note that the details of such an opening and closing method using the open-close mechanism are disclosed in Japanese Patent Laid-Open No. 8-279546 and the like.

Note that as a reticle container, a closed container can be used such as SMIF (Standard Mechanical Interface).

The ID reader 36, as shown in FIG. 4B, is fixed through a fixing member 37 to the side wall in the −Y direction inside the chamber 30. Slightly above the ID reader 36, a rack 58, which is composed of a pair of supporting members between which the ID reader 36 is located in a plan view from above, is disposed perpendicular to the side wall in the −Y direction of the chamber 30. The ID reader 36 is used to read ID information that is recorded in bar code or two-dimensional code and attached to the reticle carrier 40 mounted on the rack 58, and is a bar code reader or two-dimensional code reader. Attached to the bottom of the container main body 40A of the reticle carrier 40 is the ID information, in bar code, of the reticle R contained in the reticle carrier 40. It is noted that the reticle carrier 40 may be made of a transparent member and that the ID information may be recorded in bar code in an area other than the pattern area on the reticle R, the area including end surfaces thereof. Furthermore, it is noted that as an ID reader, a magnetic head may be used with ID information being recorded in magnetic tape, etc.

The carrier stock portion 38 is used to temporarily store the reticle carrier 40 and composed of a plurality of racks disposed apart from each other by a predetermined distance in the Z-direction.

The FOUP extension housing 20 is made to be attachable and connectable to the body (environmental chamber) 12A of the exposure-apparatus main body 12. In the −Y direction side of the FOUP extension housing 20, a FOUP extension port 60 is provided as shown in FIG. 1. The FOUP extension port 60 is placed such that the bottom thereof is at a height of about 900 mm from the floor surface as the in-out port 52 is. The reason why the FOUP extension port 60 is placed at a height of about 900 mm from the floor surface is that in the case of 12-inch wafer, on the premise that an operator transfers a Front Opening Unified Pod (for short, FOUP) as a substrate container by PGV (Person Guiding Vehicle) and carries it into and out of the apparatus, a height of about 900 mm from the floor surface is most desirable from the viewpoint of human engineering. For the same reason, the in-out port 52 is disposed at a height of about 900 mm from the floor surface.

In this embodiment, the side of the chamber 30 in which the in-out port 52 is provided and the side of the FOUP extension housing 20 in which the FOUP extension port 60 is provided are in substantially the same imaginary plane extending from the right side (the −Y direction) of the housing (environmental chamber 12A) of the exposure-apparatus main body 12.

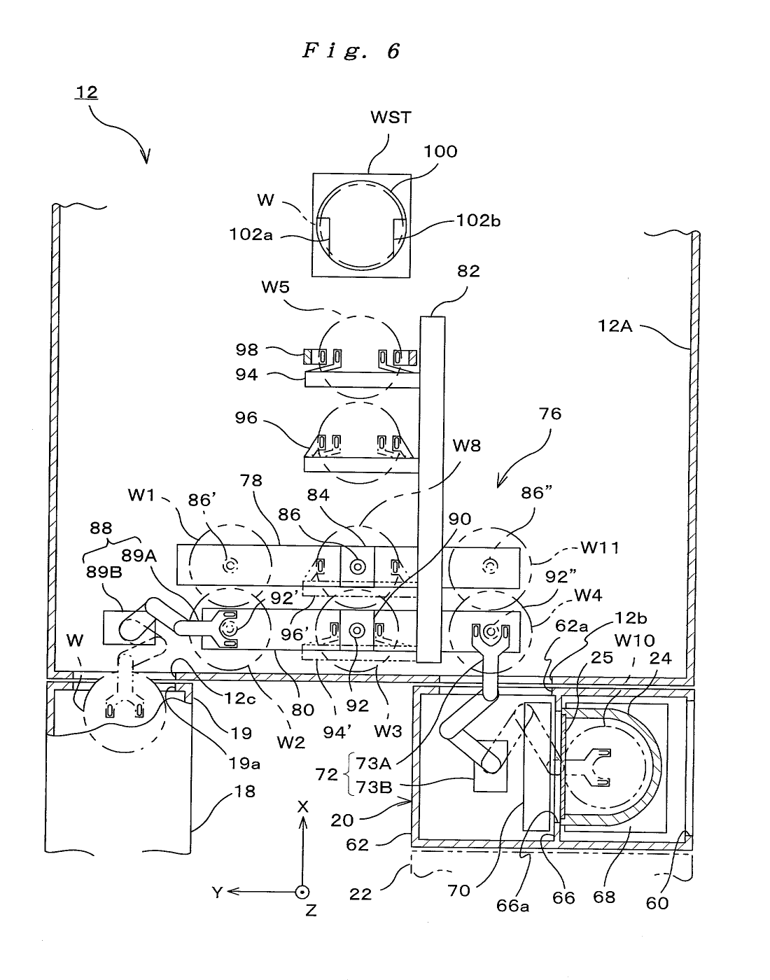

The FOUP extension housing 20 comprises a chamber 62 as a body as shown in a lateral cross-sectional view of FIG. 6. In the chamber 62, above the FOUP extension port 60, a diaphragm (not shown) is actually disposed that divides the chamber 62 into upper and lower parts. And in the upper space, part of a reticle conveying system 64 is arranged that is shown in FIG. 3. The part of the reticle conveying system 64 includes the open-close mechanism of the lid 40B of the reticle carrier 40. In addition, the lower space under the diaphragm is divided by a diaphragm 66 into two parts as shown in FIG. 6. A FOUP stage 68 on which a FOUP 24 is mounted is disposed in the space surrounded by the diaphragm 66 and a side wall of the chamber 62. On the FOUP stage 68 is mounted the FOUP 24 carried in through the FOUP extension port 60. Note that the FOUP 24 contains a plurality of wafers such that they are spaced vertically apart from each other by a predetermined distance, has an opening made in only one side thereof as shown in FIG. 6, and is a open-close-type container (closed-type wafer cassette) having a gate (lid) 25 for opening and closing the opening. Such a container is disclosed in, for example, Japanese Patent Laid-Open No. 8-279546.

To remove a wafer from the FOUP 24, it is necessary to push the FOUP 24 against an opening 66a of the diaphragm 66 and to open the gate 25 through the opening 66a. Therefore, in this embodiment an open-close mechanism (opener) 70 for the gate 25 is disposed on the +Y side of the diaphragm 66. The opening 66a is made in a position facing the FOUP extension port 60.

Furthermore, contained in the open-close mechanism 70 is an open-close member provided with a mechanism for fixing the gate 25 thereto by vacuum or mechanical connection and unfastening a key (not shown) of the gate 25. The gate 25 is opened and closed by the open-close mechanism 70 in the same manner as the lid 40B of the reticle carrier 40 is. Such an opening-and-closing sequence is disclosed in Japanese Patent Laid-Open No. 8-279546 and the like. In a usual state (the state of the FOUP not being in place) the open-close member is fitted and fixed to the opening 66a so that the inside surrounded by the diaphragm 66, etc., is not left open.

In the +Y side of the open-close mechanism 70 inside the chamber 62, a horizontal, articulated robot (scalar robot) 72 is disposed facing the FOUP stage 68. The horizontal, articulated robot 72 (hereinafter, “robot” for short, as the need arises) comprises an expandable arm 73A, which is rotatable in the X-Y plane and which can move up and down in a predetermined stroke range, and a driving portion 73B to drive the arm 73A.

Next, the sequence of removing a wafer from the FOUP 24 on the FOUP stage 68 will be described briefly. Note that although a main controller (not shown) controls the operations of various elements in the below description, description regarding the main controller will be omitted for a simpler description of the sequence.

After a FOUP 24 carried in by PGV or AGV (Auto-Guiding Vehicle) is mounted on the FOUP stage 68, the FOUP stage 68 is driven in the +Y direction by a slide mechanism (not shown), and the FOUP 24 is pushed against the diaphragm 66 so as to keep the cleanness inside the FOUP by tightly closing the opening after the gate 25 is opened. This is because inside the chamber 62 the cleanness of the space in the outer side of the diaphragm 66 may be lower than that of the space in the inner side thereof.

Next, the gate 25 of the FOUP 24 is opened using the open-close member of the open-close mechanism 70.

Next, according to the height of a wafer about to be accessed, the arm 73A is driven vertically by the driving portion 73B of the robot 72. That is, the arm 73A is driven to such a height that the arm 73A can be inserted between the wafer to be accessed and an obstacle below the wafer (another wafer or the bottom of FOUP 24).

Next, the driving portion 73B of the robot 72 rotates and extends the arm 73A, and after having inserted it below the wafer, lifts it slightly to have the wafer mounted on the arm 73A. Then the driving portion 73B contracts the arm 73A to take the wafer out of the FOUP 24, and carries the wafer to a predetermined position (indicated by an imaginary circle W4) of a wafer loader system (described later) provided inside the environmental chamber 12A of the exposure-apparatus main body 12. A wafer is conveyed by rotating, extending and contracting the arm 73A. Accordingly, in the side wall in the +X direction of the chamber 62, an opening 62a is made at a predetermined height, e.g. about 600 mm, from the floor surface, and in the side wall of the environmental chamber 12A facing the opening 62a, an opening 12b is made. An operation after having taken the wafer out of the FOUP 24 will be described later.

Referring back to FIG. 1, the chamber as the housing of the C/D 16 has a sticking-out portion near its lower end reverse to the exposure-apparatus main body 12, and on the upper surface of the sticking-out portion is formed a mount stage 26 on which a plurality of FOUP's 24 are placed. Facing the mount stage 26, as shown in FIGS. 2 and 3, on the ceiling of the clean room, a guide rail Hw as a second railway extends in the direction (the Y-direction) perpendicular to the longitudinal direction of the exposure-apparatus main body 12. From the guide rail Hw, an OHV 28 (a second ceiling-transport system) is suspended and supported that moves along the guide rail Hw and that carries the FOUP 24 containing wafers.

In this embodiment, the OHV 28 transfers the FOUP 24 containing wafers from and to the mount stage 26.

Referring back to FIG. 1, on the right side wall of environmental chamber 12A of the exposure-apparatus main body 12, a display-operation part 74 having a monitor display, a touch panel, etc., is disposed at a position corresponding almost to the height of human eyes.

Inside the environmental chamber 12A, as shown in FIG. 3, are contained an illumination optical system IOP for illuminating a reticle R as a mask with laser light guided through the beam-matching unit BMU, a reticle stage RST as a mask stage for holding the reticle R, a projection optical system PL, a wafer stage WST as a substrate stage to move in X-Y two-dimension holding a wafer W as a substrate, a wafer loader system 76, and the like.

When the exposure apparatus including the exposure-apparatus main body 12 and laser unit 14 is of a stationary-exposure-type such as a stepper, a reticle stage RST capable of being driven finely in the X-Y plane is used, and when the exposure apparatus is of a scanning-type such as a scanning-stepper, a reticle stage RST is used which is capable of being driven finely in the X-Y plane and also being driven in a predetermined stroke range and in a predetermined scanning-direction, e.g. the X-direction or Y-direction.

On the wafer stage WST, as shown in FIG. 6, a wafer holder 100 is mounted, and holds a wafer W by vacuum chuck or the like. On both ends in the Y-direction of the upper surface (wafer mounting side) of the wafer holder 100, as shown in FIG. 6, a pair of notches 102a, 102b is made into which individual pairs of claws on the ends of a stage-transport arm 98 and unload-X-axis arm 96 can be inserted, the notches extending in the X-direction and having a predetermined depth.

As shown in a lateral cross-sectional view of FIG. 6, the wafer loader system 76 comprises first and second Y-guides 78, 80 that extend in the Y-direction (the lateral direction in FIG. 6) in the −X side (the side close to inline-interface portion 18) inside the environmental chamber 12A and that are spaced apart from each other in the X-direction, and a X-guide 82 that is placed above these Y-guides (in the forward direction of FIG. 6) and that extends in the X-direction (the vertical direction in FIG. 6). The first Y-guide 78 constitutes an unload-transport-guide and the second Y-guide 80 constitutes a load-transport-guide.

On the upper surface of the first Y-guide 78, a slider 84 is mounted which is driven along the Y-guide 78 by a linear motor (not shown) or the like, and an unload-Y-axis table 86 is fixed on the slider 84.

On the +Y side (the left side in FIG. 6) of the second Y-guide 80 a horizontal, articulated robot (scalar robot) 88 is disposed. The horizontal, articulated robot 88 comprises an expandable arm 89A, which is rotatable in the X-Y plane and which can move up and down in a predetermined stroke range, and a driving portion 89B to drive the arm 89A. The robot 88 transfers a wafer W from and to the inline-interface portion 18. Therefore, in the side wall, adjacent to the environmental chamber 12A, of the body 19 of the inline-interface portion 18, as shown in FIG. 6, an opening 19a is made, and in the side wall facing the opening of the environmental chamber 12A an opening 12c is made.

On the upper surface of the second Y-guide 80 a slider 90 is mounted which is driven along the Y-guide 80 by a linear motor (not shown) or the like, and a load-Y-axis table 92 is provided on the slider 90.

In the X-guide 82, a load-X-axis arm 94 and an unload-X-axis arm 96 are provided that are driven by an up-down-movement, slide mechanism (not shown) including a mover of a linear motor and that move along the X-guide.

The load-X-axis arm 94 is driven by the up-down-movement, slide mechanism (not shown) and capable of moving from near a position that is at the end in the −X direction of the X-guide 82 and that is indicated by an imaginary line 94′ in FIG. 6 to a predetermined loading position (wafer receiving-passing position) indicated by a solid line 94 and also capable of moving vertically in a predetermined range. Near the loading position the stage-transport arm 98 is disposed. In addition, the unload-X-axis arm 96 is driven by the up-down-movement, slide mechanism (not shown) and capable of moving from a position indicated by an imaginary line 96′ in FIG. 6 to the stage-transport arm 98 in a movement plane below the movement plane of the load-X-axis arm 94 and also capable of moving vertically in a predetermined range.

Furthermore, above the first and second Y-guides 78, 80 inside the environmental chamber 12A a diaphragm (not shown) is disposed, and in the space above the diaphragm is arranged the rest of the reticle conveying system 64 (other portions than the above open-close mechanism for the reticle carrier's lid). The reticle conveying system 64 is obtained by partly modifying a known reticle conveying system having the same structure as a reticle loader system disclosed in, for example, Japanese Patent Laid-Open No. 7-240366 and U.S. patent application Ser. No. 395,315 (application date: Feb. 28, 1999) corresponding thereto. The disclosures in the above Japanese Patent Laid-Open and U.S. Patent Application are incorporated herein by reference as long as the national laws in designated states or elected states, to which this international application is applied, permit.

Next, the operation of an exposure apparatus according to this embodiment which apparatus has the structure described above will be described with reference to FIG. 6 focusing mainly on a wafer conveying sequence by the wafer loader system.

First, the operation of transporting a wafer through the inline-interface portion 18 from and to C/D 16 will be described. It is noted that although a main controller (not shown) controls the operations of various elements in the below description, description regarding the main controller will be omitted for a simpler description. Also, for the same reason the description of ON/OFF operation of vacuum chuck, etc., upon the receiving and passing of a wafer will be omitted.

It is assumed as a premise that a wafer coated with a resist has been conveyed to a predetermined position for receiving and passing, by a wafer conveying system inside the inline-interface portion 18.

a. The driving portion 89B of the robot 88, by extending and contracting, and rotating the arm 89A, moves it into the body 19 of the inline-interface portion 18 through the openings 12c, 19a so that it is placed below the wafer W held at a predetermined position by a holding member (not shown). Next, the driving portion 89B lifts the arm 89A to receive the wafer.

Then, the driving portion 89B, by extending and contracting, and rotating the arm 89A holding the wafer W, moves it to the position indicated by an imaginary circle W2 while the load-Y-axis table 92 moves to the position indicated by an imaginary line 92′.

b. Next, the driving portion 89B lowers the arm 89A so that the wafer is passed from the arm 89A to the load-Y-axis table 92. Note that the wafer can also be passed to the load-Y-axis table 92 by upward movement of the load-Y-axis table 92.

Then, the slider 90 and the load-Y-axis table 92, as one piece, are driven in the −Y direction by a linear motor or the like (not shown) so that the wafer is carried to the position indicated by an imaginary circle W3. Until the wafer has been moved into the imaginary circle W3, the load-X-axis arm 94 stands by in a range where it does not interfere with the wafer in the imaginary circle W3, for example down to the position indicated by an imaginary circle W8, and near the position indicated by an imaginary line 94′. Next, the up-down-movement, slide mechanism (not shown) drives the load-X-axis arm 94 toward the position indicated by an imaginary line 94′ and places it at a position where the wafer's center and the center between the claws of the load-X-axis arm 94 substantially coincide with each other.

Then the up-down-movement, slide mechanism drives the load-X-axis arm 94 upwards for the wafer to be passed from the load-Y-axis table 92 to the load-X-axis arm 94. Note that the wafer can also be passed to the load-X-axis arm 94 by downward movement of the load-Y-axis table 92.

c. After the wafer is passed to the load-X-axis arm 94, the up-down-movement, slide mechanism drives the load-X-axis arm 94 from the position of the imaginary line 94′ to the loading position indicated by a solid line in FIG. 6. In this way, the wafer W reaches the position indicated by an imaginary circle W5.

After the load-X-axis arm 94 starts to move toward the loading position, the linear motor or the like (not shown) moves the load-Y-axis table 92 to the left end position indicated by the imaginary line 92′ to prepare for transporting a next wafer.

d. After the load-X-axis arm 94 reaches the loading position, the up-down-movement, slide mechanism drives the load-X-axis arm 94 downwards, and the wafer is passed from the load-X-axis arm 94 to the stage-transport arm 98. Note that the wafer can also be passed to the stage-transport arm 98 by downward movement of the stage-transport arm 98.

After the end of the transport, the up-down-movement, slide mechanism starts moving the load-X-axis arm 94 towards the position indicated by an imaginary line 94′ to prepare for transporting the next wafer.

After the load-X-axis arm 94 retreats from the loading position, an up-down-movement mechanism (not shown) drives the stage-transport arm 98 upwards by a predetermined amount. Next, an up-down-movement, slide mechanism drives the unload-X-axis arm 96 to straight below the stage-transport arm 98 located at the loading position. And the stage-transport arm 98 and the unload-X-axis arm 96 stand by at their positions.

e. Meanwhile, during the operation, including standby, of the load-X-axis arm 94, the stage-transport arm 98 and the unload-X-axis arm 96, another wafer previously mounted on the wafer stage WST is being aligned and exposed.

After a pattern on a reticle R has been transferred (exposed) onto all shot areas on the wafer, a stage controller (not shown) moves the wafer stage WST from an exposure end position in FIG. 6 toward the loading position to move the already-exposed wafer to an unloading position (that is, the loading position).

After the wafer stage has moved to the loading position, the claws, provided with a chucking portion, at the end of the unload-X-axis arm 96 engage with the notches 102a, 102b of the wafer holder 100.

Then, the up-down-movement, slide mechanism (not shown) drives the unload-X-axis arm 96 upwards by a predetermined amount for the already-exposed wafer to be unloaded and passed from the wafer holder 100 on the wafer stage WST to the unload-X-axis arm 96.

Next, the up-down-movement, slide mechanism (not shown) drives the unload-X-axis arm 96 to the position indicated by an imaginary line 96′ in FIG. 6 to transfer the wafer from the loading position indicated by the imaginary circle W5 to a position indicated by an imaginary circle W8.

Note that if, before the end of the above sequence, the unload-Y-axis table 86 is not at the position indicated by a solid line 86, the unload-X-axis arm 96 stands by at the position indicated by a solid line 96 in FIG. 6.

After the unload-X-axis arm 96 retreats from the loading position, the up-down-movement, slide mechanism (not shown) drives the stage-transport arm 98 downwards, and the wafer to be exposed is passed from the unload-X-axis arm 96 to the wafer holder 100. When the stage-transport arm 98 moves downwards, the claws, provided with a chucking portion, at the end of the stage-transport arm 98 fit with the notches 102a, 102b of the wafer holder 100.

After the stage-transport arm 98 is lowered to be apart from the wafer's back surface by a predetermined amount, the stage controller (not shown) drives the wafer stage WST toward a start position of an exposure sequence. Then the exposure sequence (search-alignment, fine alignment such as EGA, and exposure) is performed on the wafer W on the wafer holder 100. Because the exposure sequence is the same as in the usual scanning-stepper or stepper, detailed description will be omitted.

When the wafer stage moves to the start position of exposure, the wafer stage WST moves smoothly without the claws of the stage-transport arm 98 touching the wafer holder 100 because the wafer holder 100 has the notches 102a, 102b made thereon.

As described above, because upon the exchange of wafers on the wafer holder 100, the exposure apparatus of this embodiment efficiently uses the high-speed movement of the wafer stage WST, the time for replacing a wafer can be shortened, thereby improving the throughput.

The structure and operation of the wafer holder 100, the unload-X-axis arm 96, the stage-transport arm 98 and the like are disclosed in International Application PCT/JP98/05453 and the like. The disclosure in the above International Application is incorporated herein by reference as long as the national laws in designated states or elected states, to which this international application is applied, permit.

After the wafer stage WST retreats from the loading position, at the loading position the up-down-movement, slide mechanism (not shown) drives the stage-transport arm 98 upwards to the position for receiving and passing a wafer from and to the load-X-axis arm 94.

f. Meanwhile, after the already-exposed wafer reaches the position indicated by the imaginary circle W8, the up-down-movement, slide mechanism lowers the unload-X-axis arm 96 to pass the wafer from the unload-X-axis arm 96 to the unload-Y-axis table 86. Then the up-down-movement, slide mechanism drives the unload-X-axis arm 96 to the loading position, and the unload-X-axis arm 96 stands by to prepare for unloading the next wafer.

After the unload-X-axis arm 96 has moved to such a position that the unload-X-axis arm 96 does not interfere with the wafer on the unload-Y-axis table 86, the slider 84 and the unload-Y-axis table 86, as one piece, are driven to the position indicated by an imaginary line 86′ by a linear motor or the like (not shown). Therefore, the wafer is carried from the position of the imaginary circle W8 to the position indicated by an imaginary circle W1.

g. Next, the driving portion 89B of the robot 88, by extending and contracting, and rotating the arm 89A, inserts it below the already-exposed wafer supported by the unload-Y-axis table 86, and then lifts it by a predetermined amount. In this way, the wafer is passed from the unload-Y-axis table 86 to the arm 89A. After this, the unload-Y-axis table 86 is moved to the position of the solid line 86 by the linear motor or the like (not shown) to prepare for the next wafer transport.

After the unload-Y-axis table 86 retreats from the position of the imaginary line 86′, the driving portion 89B, by extending and contracting, and rotating the arm 89A, returns the already-exposed wafer to a predetermined receiving and passing position inside the inline-interface portion 18, and then the arm 89A returns to a standby position inside the environmental chamber 12A.

The already-exposed wafer that has been returned to inside the inline-interface portion 18 is conveyed to the inside of the C/D 16 by a wafer driving system (not shown).

In the above manner, the operation sequence of transferring wafers from and to the C/D 16 through the inline-interface portion 18 is performed.

Next, the operation sequence of storing and conveying a wafer by using the FOUP 24 will be described.

First, in the same way as described above, a not-exposed wafer taken out of the FOUP 24 on the FOUP stage 68 is carried to the position of an imaginary circle W4 by the arm 73A of the robot 72, and passed to the load-Y-axis table 92 standing by at the position of an imaginary line 92″.

After that, by the same sequence as the above sequence b. through f. for transferring wafers from and to the C/D 16, the already-exposed wafer is carried to the position indicated by an imaginary circle W11 in FIG. 6.

After the already-exposed wafer W has been carried to the position of the imaginary circle W11, the driving portion 73B of the robot 72 inserts the arm 73A below the already-exposed wafer W held by the unload-Y-axis table 86, and then lifts it by a predetermined amount. In this way, the wafer W is passed from the unload-Y-axis table 86 to the arm 73A of the robot 72. Next, the driving portion 73B of the robot 72, by extending/contracting, rotating and lifting the arm 73A, moves the wafer W from the position W11 to a position W10. Specifically, the driving portion 73B raises the wafer W via the arm 73A to a height, and extends the arm 73A to insert the wafer W slightly above a storing rack inside the FOUP 24. Then the driving portion 73B lowers the arm 73A, passes the wafer W to the storing rack, and contracts the arm 73A to move it back from the FOUP.

After the whole operation on the wafer inside the FOUP 24 has finished, the open-close mechanism 70 closes the gate 25 of the FOUP 24 and locks the gate 25. And the FOUP stage 68 is driven in the −Y direction by an up-down-movement, slide mechanism (not shown), and stands by to prepare for transport of the FOUP 24 by PGV, AGV, etc.

As described above, according to this embodiment the laser unit 14 is disposed in the area of the floor surface F, the width of which area is defined by the maintenance areas on both sides of the exposure-apparatus main body 12 inclusive, and does not stick out in the Y-direction relative to both sides of the exposure-apparatus main body 12. Therefore, the necessary floor area can be reduced.

Furthermore, in this embodiment, the exposure-apparatus main body 12 has such a structure that maintenance thereof can be performed from four directions, right, left, front and back, and the exposure-apparatus main body 12 and the laser unit 14 are so arranged on the floor surface F that maintenance area WMA of the laser unit 14 can also be used as part of the back side maintenance area of the exposure-apparatus main body 12. Accordingly, the necessary floor area can be reduced compared with the case where maintenance areas of the laser unit 14 and the exposure-apparatus main body 12 are separate.

In addition, in this embodiment the laser unit 14 is connected through the beam-matching unit BMU to the exposure-apparatus main body 12, and the beam-matching unit BMU is disposed below the floor surface F on which the exposure-apparatus main body 12 is disposed. Because the beam-matching unit BMU (an obstacle) is not on the floor, the maintenance of the exposure apparatus can be done easily and comfortably. However, the beam-matching unit BMU (guide optical system) may be disposed above the floor surface F on which the exposure-apparatus main body 12 is provided. Also in this case, maintenance thereof is easy.

In addition, in this embodiment because the C/D 16 can be connected to the surface, reverse to the laser unit 14, of the exposure-apparatus main body 12 through the inline-interface portion 18, a lithography system 10 including the C/D 16 connected in-line with the exposure-apparatus main body 12 is of a so-called front-inline-type and has an almost rectangular shape in a plan view. Accordingly, in a case where a plurality of such lithography systems 10 are arranged in a clean room, they can be arranged more efficiently than left-inline-type or right-inline-type systems are, and because nothing is further out than both side surfaces of the exposure-apparatus main body 12, the clean room's space can be efficiently used. Furthermore, if necessary, adjacent lithography systems 10 may share a maintenance area or at least part of a transport path for AGV, etc., to improve space-efficiency.

In addition, because there is an empty space beside the inline-interface portion 18 and in front of the exposure-apparatus main body 12, by using the space as a maintenance area, it is easy to perform maintenance from the front of the exposure-apparatus main body 12. Therefore, the advantage of capability of maintenance from the front can be effectively utilized.

The lithography system 10 according to this embodiment is by the length of the inline-interface portion 18 longer in the longitudinal direction than a front-inline lithography system according to the prior art. However, because the exposure-apparatus main body 12 and the laser unit 14 are so arranged on the floor surface F that the back side maintenance area of the exposure-apparatus main body 12 and that of the laser unit 14 occupy the same area, the necessary floor area almost does not increase compared with a front-inline lithography system according to the prior art while setting apart an area for maintenance from the front. This can be obviously seen by comparing a length L2′ in FIG. 2 and a length L2 in FIG. 31.

Furthermore, in this embodiment it is easy to remove the attachable inline-interface portion 18, and the maintenance area can be expanded to include the area that was occupied by the inline-interface portion 18. In this case, maintenance thereof becomes even easier. Also, in this embodiment it is easy to remove the attachable reticle port housing 22 and FOUP extension housing 20, and the maintenance area can include the area that was occupied by the reticle port housing 22 and the FOUP extension housing 20. In this case, maintenance thereof becomes even easier. That is, maintenance of the exposure-apparatus main body 12 according to this embodiment can be performed from the front in the same way as with a so-called stand-alone exposure, and the advantage, of the exposure apparatus according to this embodiment, of capability of maintenance from the front as well as from both sides can be effectively utilized.

Furthermore, the C/D 16 can be connected to the front surface of the exposure apparatus according to this embodiment, which front surface is an end surface of the exposure apparatus in the longitudinal direction, and in the side of the exposure apparatus which is in front of the optical axis of the projection optical system, and which is connected to the C/D 16 (in the end of the exposure-apparatus main body 12, which end is close to the C/D 16), a delivery port 42 is provided to and from which the reticle carrier 40 are carried by the OHV 44 moving along the guide rail Hr extending on the ceiling with the reticle carrier 40 containing a reticle. Therefore, while on the back side of the exposure-apparatus main body 12, an illumination optical system IOP connected to the laser unit 14 are provided, a reticle conveying system can be arranged on the front side. Accordingly, in the case of adopting OHV as the reticle conveying system, the structure of the reticle conveying system inside the exposure apparatus is prevented from becoming complicated. In this case, the reticle conveying system 64 can be disposed at a different height from and along the wafer loader system 76, and such a reticle conveying system may have the same structure as that of an exposure apparatus according to the prior art.

The structure of the lithography system according to this embodiment shows an example, and this invention is not limited to it, needless to say. That is, only one of the reticle port housing 22 and the FOUP extension housing 20 may be disposed parallel to the inline-interface portion 18. Note that in the case of the reticle port housing 22 being included in the exposure-apparatus main body 12, it is necessary to provide an delivery port corresponding to the delivery port 42 on the front side of the ceiling portion of the environmental chamber 12A of the exposure-apparatus main body 12.

For example, in the case where only the reticle port housing 22 as a mask-transport system housing is disposed parallel to the inline-interface portion 18 and adjacent to the exposure-apparatus main body 12, the in-out port 52 may be disposed in the side of the chamber 30 of the reticle port housing 22, which side faces the C/D 16. Note that in this case because it is necessary to manually carry a reticle carrier in and out, it is preferable to set the height, from the floor surface, of the in-out port 52 to be about 900 mm.

Needless to say, in the case where only the reticle port housing 22 is disposed parallel to the inline-interface portion 18 and adjacent to the exposure-apparatus main body 12, in the same manner as in the above embodiment, the reticle port housing 22 may be so disposed that a side surface thereof and a side surface of the exposure-apparatus main body 12 are almost in the same plane, and the in-out port 52 for a reticle carrier may be disposed in that side of the reticle port housing 22. In this case, along that side surface of the exposure-apparatus main body 12, a rail of an auto-conveying system such as AGV can be arranged on the floor surface, and a reticle carrier 40 containing a reticle can be carried in and out by the auto-conveying system through the delivery port in the side of the reticle port housing 22.

In any of the above cases, if the exposure apparatus (the exposure-apparatus main body 12) has such a structure that maintenance from the front as well as from both sides is possible, it is preferable that at least one of the inline-interface portion 18 and the reticle port housing 22 is attachable so as to ensure a broader maintenance area in front of the exposure apparatus and make maintenance even easier.

In addition, for example, in the case where only the FOUP extension housing 20 as a substrate-container-extension housing is disposed parallel to the inline-interface portion 18 and adjacent to the exposure-apparatus main body 12, the FOUP extension port 60 may be disposed in the side of the chamber 62 of the FOUP extension housing 20, which side faces the C/D 16. Note that in this case because it is necessary to manually carry a FOUP in and out, it is preferable to set the height, from the floor surface, of the extension port 60 to be about 900 mm.

Needless to say, in the case where only the FOUP extension housing 20 is disposed parallel to the inline-interface portion 18 and adjacent to the exposure-apparatus main body 12, in the same manner as in the above embodiment, the FOUP extension housing 20 may be so disposed that a side surface thereof and a side surface of the exposure-apparatus main body 12 are almost in the same plane, and the extension port 60 of FOUP may be disposed in that side of the FOUP extension housing 20. In this case, along that side surface of the exposure-apparatus main body 12, a rail of an auto-conveying system such as AGV can be arranged on the floor surface, and a FOUP can be carried in and out by the auto-conveying vehicle through the extension port 60.

In any of the above cases, if the exposure apparatus (the exposure-apparatus main body 12) has such a structure that maintenance from the front as well as from both sides is possible, it is preferable that at least one of the inline-interface portion 18 and the FOUP extension housing 20 is attachable so as to ensure a broader maintenance area in front of the exposure apparatus and make maintenance even easier.

Furthermore, in this embodiment, although the C/D 16 is connected to the front of the exposure apparatus, and the OHV 28 for wafers is adopted as in the prior art, the guide rail Hw for the OHV 28 and the guide rail Hr for the OHV 44 are parallel to each other. Therefore, these guide rails are easily arranged on the ceiling portion.

The lithography system 10 according to this embodiment comprises the reticle port housing 22 that is disposed parallel to the inline-interface portion 18, that has the delivery port 42, for the reticle carrier 40 containing a reticle, on the ceiling portion thereof, and that has a reticle conveying system therein, and the FOUP extension housing 20 that is disposed adjacent to the reticle port housing 22 and parallel to the inline-interface portion 18, and that has the FOUP extension port 60. Accordingly, an empty space beside the inline-interface portion 18 is effectively utilized.

Furthermore, in the lithography system 10 according to this embodiment, the FOUP extension housing 20 is so disposed that a side surface thereof, a side surface of the exposure-apparatus main body 12 and a side surface of the reticle port housing 22 are almost in the same plane; the extension port 60 of FOUP is disposed in that side of the FOUP extension housing 20, and in that side of the reticle port housing 22 is disposed the in-out port 52 for reticle carriers.

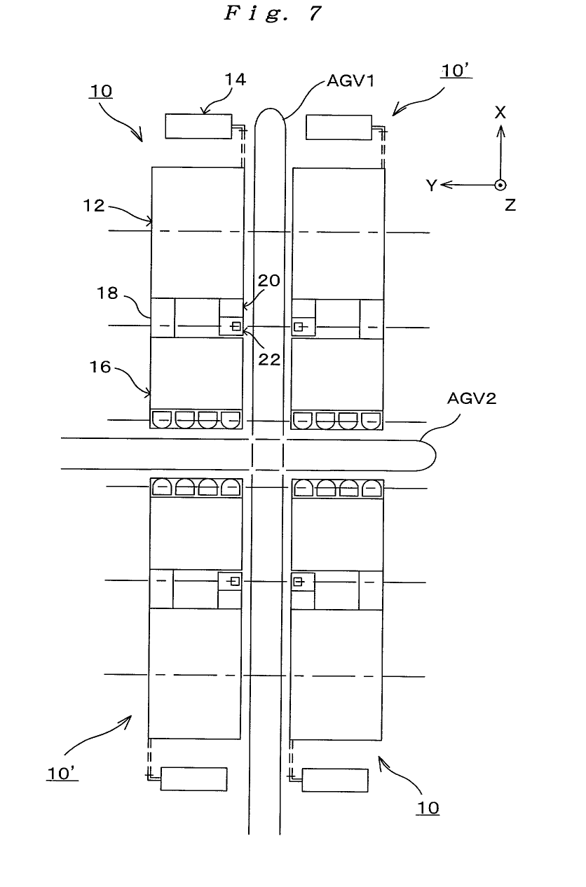

Accordingly, for example as shown in FIG. 7, in a case where a plurality of lithography systems 10 and a plurality of lithography systems 10′ which are different from the lithography system 10 only in that some parts thereof (an inline-interface portion, a reticle port housing and a FOUP extension housing) are inverted in the lateral direction are arranged in a clean room, by providing a rail (AGV1 in FIG. 7) of an auto-conveying system such as AGV on the floor surface and along a side of exposure apparatuses (exposure-apparatus main bodys 12), a FOUP 24 can be carried in and out by an auto-conveying system through the FOUP extension port 60 of the FOUP extension housing 20, and a reticle carrier 40 containing a reticle can be carried in and out by the auto-conveying system through the in-out port 52 for a retcile carrier, which port 52 is provided in that side of the reticle port housing 22. In this case the auto-conveying system for a reticle carrier and the auto-conveying system for a FOUP can share a rail. In addition, a rail of AGV (AGV2 in FIG. 7) for transferring a FOUP from and to the C/D 16 may be arranged in a direction perpendicular to the rail AGV1. Also by an auto-conveying system with AGV2 as the rail, FOUP's can be transported from and to a plurality of C/D's.

In addition, because the FOUP extension port 60 and the in-out port 52 for a reticle carrier are disposed at a predetermined height from the floor surface, specifically about 900 mm, if a FOUP and a reticle carrier are manually transferred by using PGV (Person Guiding Vehicle) instead of AGV, the lithography system 10 according to this embodiment provides a working environment ideal in terms of human engineering.

Note that although this embodiment, as shown in FIG. 2, describes the case where the maintenance area behind the exposure-apparatus main body 12 includes the maintenance area WMA of the laser unit 14, this invention is not limited to it. The exposure-apparatus main body 12 and the laser unit 14 may be so arranged in the longitudinal direction on the floor surface that the maintenance areas of the exposure-apparatus main body 12 and the laser unit 14 at least partially overlap. Also in this case the necessary area of the floor can be reduced compared to the case where the maintenance areas of the exposure-apparatus main body 12 and the laser unit 14 are separate.

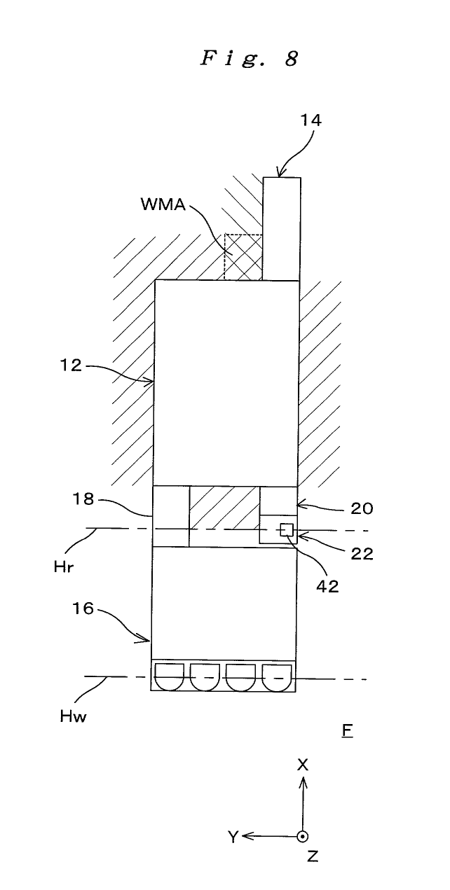

Furthermore, although this embodiment describes the case where the laser unit 14 is disposed apart from the exposure-apparatus main body 12 by a predetermined distance on the floor surface F while optically connecting the two with the beam-matching unit BMU, this invention is not limited to it. The housing of the laser unit 14 may be disposed adjacent or connected to the body (environment chamber) of the exposure-apparatus main body 12. In this case, as shown in FIG. 8, the laser unit 14 may be disposed on the floor surface F such that the longitudinal direction thereof coincides with that of the exposure-apparatus main body 12. A symbol WMA in FIG. 8 indicates a maintenance area shared by the laser unit 14 and the exposure-apparatus main body 12.

The exposure apparatus in FIG. 8 has a shorter optical path from the laser unit 14 to the exposure-apparatus main body 12, and therefore the number of optical elements along the optical path will be reduced. Then the variation of the transmittance thereof is reduced, and because the range to be purged is shortened, the control of gas concentration and maintenance is easier. In this case, although the laser unit 14 can be KrF excimer laser, a unit emitting laser light of vacuum ultraviolet, especially of a range of 120 to 200 nm, such as ArF excimer laser (oscillation wavelength 193 nm) or F₂ laser (oscillation wavelength 157 nm) is preferred.

Note that in the case of FIG. 8, because the laser unit 14 is disposed such that the longitudinal direction thereof coincides with that of the exposure-apparatus main body 12 (the arrangement direction of the lithography system 10), a laser tube filled with a plurality of noble gases, i.e. a laser resonator, is disposed in the longitudinal direction thereof, and that reflection optical elements for bending the optical path are not necessary like the prior art.

Furthermore, a lithography system, as shown in FIG. 8, can comprise as the laser unit 14 a laser plasma unit emitting soft X-ray having a wavelength of 5 to 15 nm (EUV light), a high power laser unit employing semiconductor laser excitation, or the like. In this case, because reflection optical elements on the optical path of EUV light from the laser unit 14 to the exposure-apparatus main body 12 are reduced in number, the energy loss of the EUV light can be prevented.

Note that although this embodiment describes the case where the exposure-apparatus main body 12 has such a structure that maintenance can be performed from four directions, right, left, front and back, this invention is not limited to it. That is, as long as the exposure-apparatus main body has such a structure that maintenance can be performed from at least both sides, the necessary area of the floor can be reduced by providing the laser unit in an area including maintenance areas on both sides of the exposure-apparatus main body 12. Therefore, in a case where a plurality of lithography systems are arranged in a clean room, it is possible to improve space efficiency of the clean room. Also, when the exposure-apparatus main body 12 has such a structure that maintenance can be performed from only both sides, the exposure apparatus (the exposure-apparatus main body) and the C/D 16 may be directly connected to each other without the inline-interface portion 18, or if the exposure apparatus is connected to the C/D 16 through the inline-interface portion 18, the inline-interface portion 18, the FOUP extension housing 20 and the reticle port housing 22 need not be attachable.

<<A Second Embodiment>>

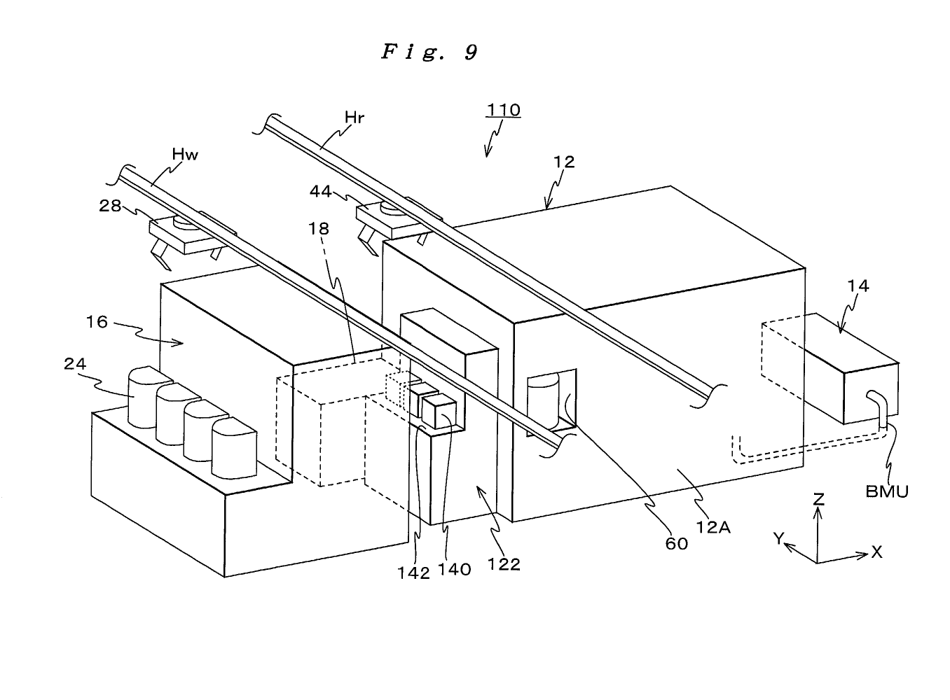

Next, a second embodiment of the present invention will be described below with reference to FIGS. 9 to 11. Note that the same elements as, or equivalent elements to, those of the first embodiment are represented by the same symbols, and that brief or no descriptions about these elements will be presented.

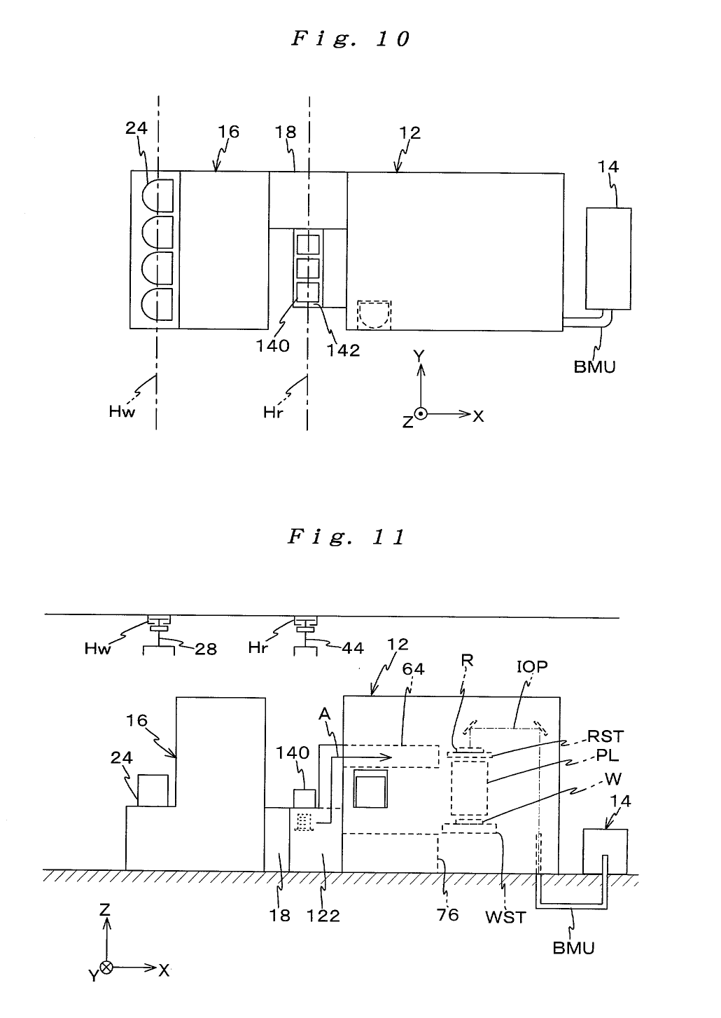

FIG. 9 shows the schematic, oblique view of a lithography system 110 of the second embodiment according to this invention; FIG. 10 shows a plan view of the lithography system 110, and FIG. 11 shows a side view of the lithography system 110.

The lithography system 110, as shown in FIG. 9, comprises an exposure apparatus comprising an exposure-apparatus main body 12, a beam-matching-unit BMU and a laser unit 14; a C/D 16 that serves as a substrate process unit and that is connected through an inline-interface portion 18 to the front end of the exposure-apparatus main body 12; and a reticle port housing 122 that serves as a mask-transport-system housing, that is disposed parallel to the inline-interface portion 18 and in front of the exposure-apparatus main body 12, and that is connected to the exposure-apparatus main body 12.

In the second embodiment, on the −Y side of a environmental chamber 12A of the exposure-apparatus main body 12, a FOUP extension port 60 is disposed at a height of about 900 mm from the floor, which is determined from the viewpoint of human engineering. The inside structure of the environmental chamber 12A in which the FOUP extension port 60 is provided is the same as that of the FOUP extension housing (chamber) 62 in FIG. 6.

The reticle port housing 122, as shown in FIGS. 9 and 10, is provided with an delivery port 142 on which three reticle carriers 140 as mask containers can be placed along a guide rail Hr. The height of the delivery port 142 from the floor is also about 900 mm, which height is determined from the viewpoint of human engineering. From and to the delivery port 142, the OHV 44 can transfer reticle carriers 140. In addition, the delivery port 142 is suitable for an operator to manually carry reticle carriers 140 transported with PGV, etc., from and to.

As such a reticle carrier 140 is used a SMIF (Standard Mechanical Interface) pod, a closed container, which can contain a plurality of reticles vertically spaced a predetermined distance apart from each other. The reticle carriers 140 comprises a carrier main portion provided with a plurality of racks for containing reticles to be vertically spaced from each other, a cover firmly fastened to the carrier main portion, and a lock mechanism that is provided on the bottom of the carrier main portion and that locks the cover. Needless to say, a reticle carrier 140 may contain only one reticle R.

Corresponding to the structure of the reticle carrier 140, in the delivery port 142 of the reticle port housing 122, on which reticle carriers 140 are placed, three opening are made that are slightly larger than the carrier main portion of a reticle carrier 140 and that are spaced a predetermined distance apart in the Y-direction. Each of the openings is usually, firmly closed by an open-close member that constitutes an open-close mechanism (not shown) contained in the reticle port housing 122. The open-close member has a mechanism (not shown) that attaches to the bottom surface of the carrier main portion by vacuum chuck or by mechanical connection and that unfastens the lock mechanism (not shown) provided on the carrier main portion. Hereinafter, the unlock mechanism is referred to as an “attach-and-unlock mechanism” for the sake of convenience.

The open-close mechanism unfastens the lock mechanism by using the attach-and-unlock mechanism, and, after the open-close member has attached to the carrier main portion, can separate from the cover the carrier main portion holding a plurality of reticles by lowering the open-close member by a predetermined amount while the inside of the reticle port housing 122 is isolated from the outside. In other words, the open-close mechanism can open the cover of the reticle carrier 140 while maintaining the isolation between the inside and outside of the reticle port housing 122.

After the carrier main portion containing a plurality of reticles, or a reticle, has been separated from the cover, the reticle conveying system 64 that includes a robot (not shown) and that serves as a mask-transport system conveys the reticles along a path indicated by an arrow A in FIG. 11, and stores them in a reticle store portion (not shown) inside the exposure-apparatus main body 12. And a reticle loader (not shown) transfers the reticles between the reticle store portion and a reticle stage RST.

Meanwhile, after tasks of the reticles such as exposure through them has been finished, the reticle conveying system 64 conveys the reticles along the path in reverse to below the delivery port 142, and then the open-close mechanism fits the cover to the carrier main portion in the opposite order to that described above so that the reticles are enclosed in the reticle carrier 140. After that, the reticle carrier 140 stands by for transport by the OHV 44. Note that before a reticle R are conveyed from the reticle stage RST to the delivery port 142, it is not necessary to return the reticle R to the reticle store portion. Furthermore, without the reticle store portion a reticle may be conveyed between the carrier main portion separated from the cover and the reticle stage RST. The structure of the other parts is the same as that of the first embodiment.

By using the lithography system 110 of the second embodiment, the effect equivalent to that of the first embodiment can be obtained. Besides, reticles contained in the reticle carrier 140 are transported by the OHV 44 moving along the guide rail Hr provided on the ceiling of the clean room, and the delivery port 142 on which three reticle carriers 140 can be placed along the guide rail Hr is provided on the reticle port housing 122 below the guide rail Hr. Therefore, reticle carriers 140 can be conveyed to the three positions on the delivery port 142 by the OHV 44, and so at most three reticle carriers 140 can be placed on the delivery port 142 at the same time. Accordingly, in the second embodiment, by conveying individual reticles in the reticle carriers 140 onto the reticle stage RST one at a time, the time necessary for the whole process of transport of reticles, which time includes a time for exchange of reticles, can be shortened compared to conveying reticle carriers 140 one by one from the outside, and the throughput can be improved.

In addition, because the delivery port 142 is provided in the front side of the exposure apparatus which is in front of the optical axis of a projection optical system PL and which is connected to the C/D 16 while an illumination optical system IOP is provided behind the exposure apparatus, the reticle conveying system can be disposed in front of the projection optical system PL. Therefore, a conveying system of an exposure apparatus of the prior art can be used as the reticle conveying system by slightly modifying.

Furthermore, because the delivery port 142 is disposed at a height of about 900 mm from the floor surface, an operator manually can carry a reticle carriers 140 into and out of the delivery port 142 under suitable conditions also from the viewpoint of human engineering.

<<A Third Embodiment>>

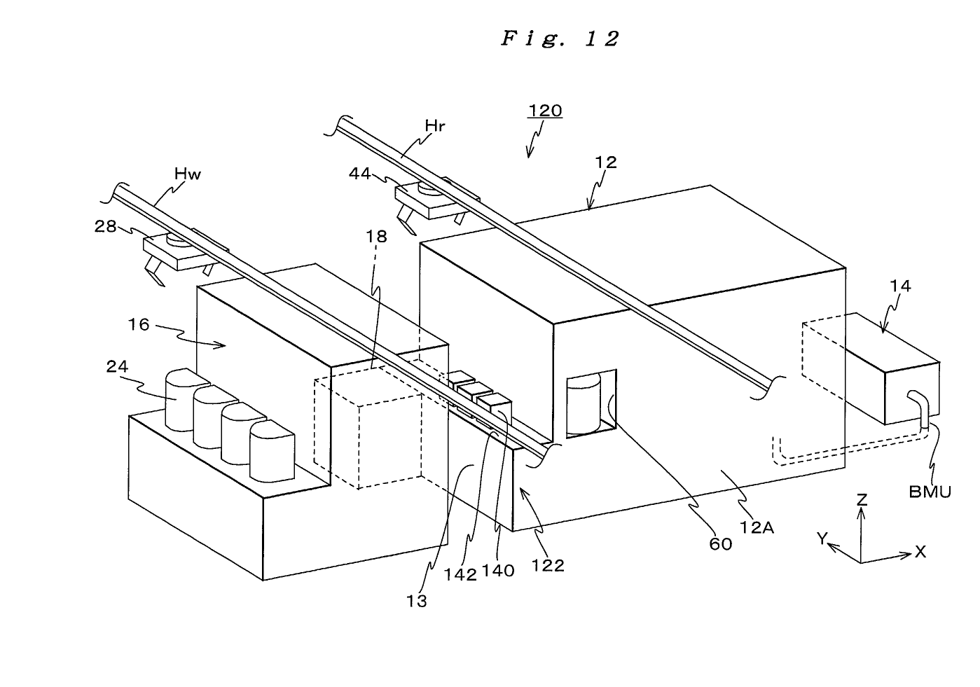

Next, a third embodiment of the present invention will be described below with reference to FIGS. 12 to 14. Note that the same elements as, or equivalent elements to, those of the first and second embodiments are represented by the same symbols, and that brief or no descriptions about these elements will be presented.

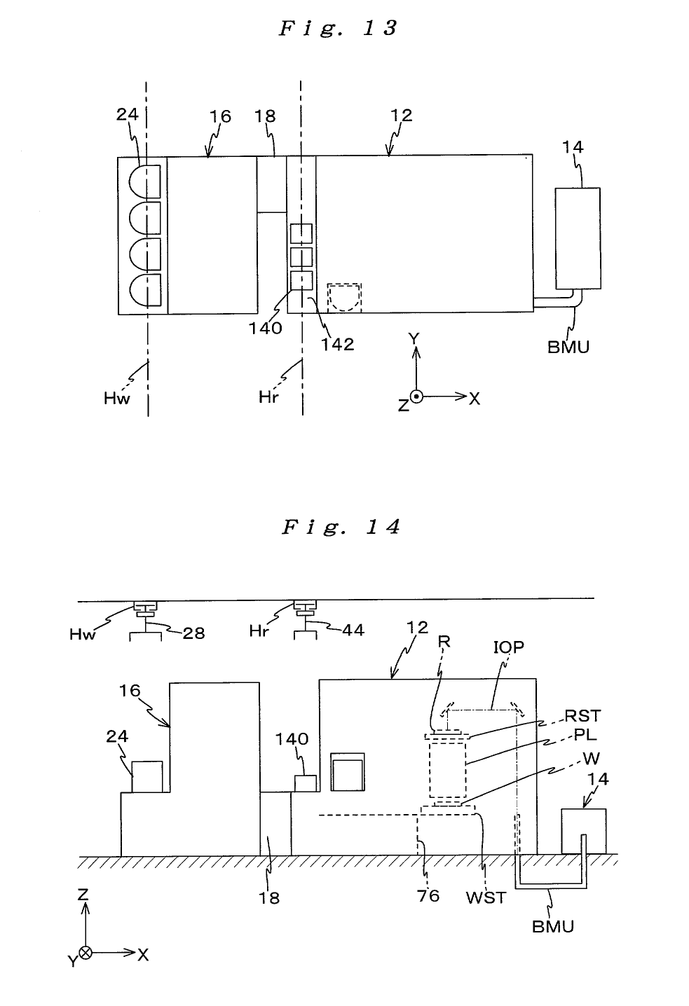

FIG. 12 shows the schematic, oblique view of a lithography system 120 of the third embodiment; FIG. 13 shows a plan view of the lithography system 120, and FIG. 14 shows a side view of the lithography system 120.

The lithography system 120, as a whole, has the same structure as the lithography system 110 according to the second embodiment, but is different in the following points.

That is, in the lithography system 120 an environmental chamber 12A of an exposure-apparatus main body 12 has a sticking-out portion 13 formed on the side thereof in the −X direction, and on the upper surface of the sticking-out portion 13, as shown in FIGS. 12 and 13, is disposed an delivery port 142 on which three reticle carriers 140 as mask containers can be placed along the guide rail Hr. And in this case, reticles in a carrier main portion that is carried to the delivery port 142 and separated from a cover thereof by a open-close mechanism (not shown) are conveyed through the +Y side space of the FOUP extension port 60 to a reticle store portion above the FOUP extension port 60. The structure of the other parts is the same as that of the lithography system 110 according to the second embodiment.

By using the lithography system 120 according to the third embodiment, the effect equivalent to that of the second embodiment can be obtained. In addition, because the length of the inline-interface portion 18 can be shortened, the footprint thereof can be reduced by that amount.

<<A Fourth Embodiment>>

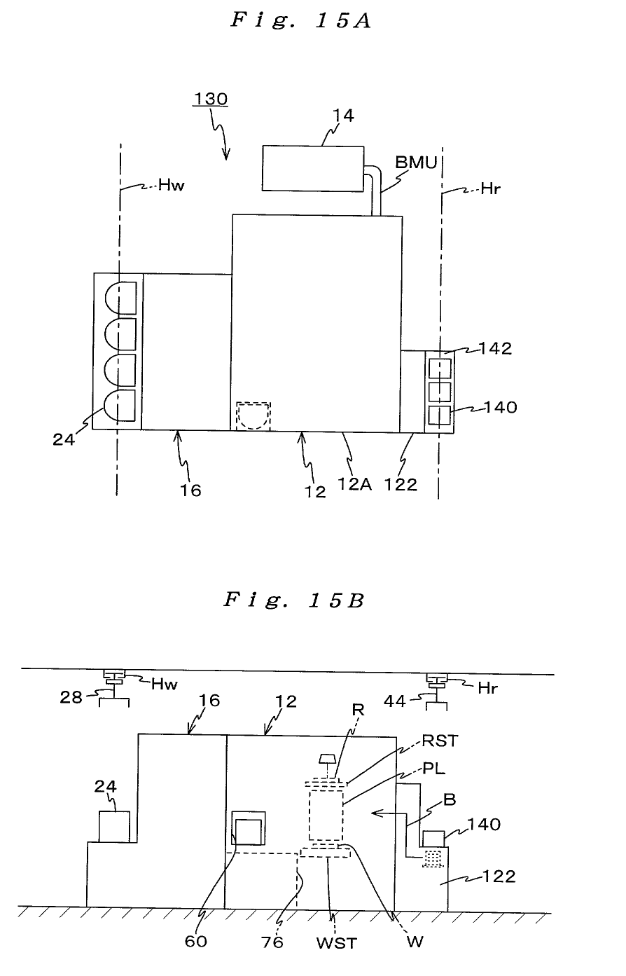

Next, a fourth embodiment of the present invention will be described below with reference to FIGS. 15A to 15B. Note that the same elements as, or equivalent elements to, those of the first and second embodiments are represented by the same symbols, and that brief or no descriptions about these elements will be presented.

FIG. 15A shows a plan view of a lithography system 130 according to the fourth embodiment, and FIG. 15B shows a front view of the lithography system 130.

The lithography system 130 according to the fourth embodiment, as seen in FIGS. 15A and 15B, is of a left-inline type where a C/D 16 as a substrate process unit is connected to the left side of an exposure-apparatus main body 12 and which is different from the type of the first through third embodiments.

The lithography system 130, as shown in FIG. 15A, comprises an exposure apparatus comprising the exposure-apparatus main body 12, a beam-matching-unit BMU and a laser unit 14; the C/D 16 connected through an inline with the left side of the exposure-apparatus main body 12; and a reticle port housing 122 that serves as a mask-transport-system housing and that is connected to near the front end of the right side of the exposure-apparatus main body 12.

In the lithography system 130 according to the fourth embodiment, in the left end of the front side of a environmental chamber 12A of the exposure-apparatus main body 12, the FOUP extension port 60 is disposed at a height of about 900 mm from the floor, which is determined from the viewpoint of human engineering as in the above. The inside structure of the environmental chamber 12A in which the FOUP extension port 60 is provided is the same as that of the FOUP extension housing 62 in FIG. 6.

The reticle port housing 122, as shown in FIGS. 15A, is provided with an delivery port 142 on which three reticle carriers 140 as mask containers, each of which is constituted by a SMIF (Standard Mechanical Interface) pod, can be placed along a guide rail Hr as a first railway. The height of the delivery port 142 from the floor is also about 900 mm, which height is determined from the viewpoint of human engineering. The OHV 44 can carry reticle carriers 140 from and to the delivery port 142. In addition, the delivery port 142 is suitable for an operator to manually carry reticle carriers 140 transported with PGV, etc., from and to.

In this case, as seen in FIG. 15A, a guide rail Hw as a second railway along which the OHV 28 moves that serves as a second ceiling-transport system and that conveys FOUP's 24 containing wafers to the mount stage of the C/D 16, and the guide rail Hr along which the OHV 44 moves that serves as a first ceiling-transport system and that conveys reticle carriers 140 from and to the delivery port 142 are disposed parallel to each other on the ceiling portion (ceiling surface) of the clean room.

In the lithography system 130, a robot (not shown) that transfers wafers between the inside of the C/D 16 and a wafer loader system 76 inside the environmental chamber 12A of the exposure-apparatus main body 12 also transfers wafers between a FOUP24 inside the FOUP extension port 60 and the wafer loader system 76.

Furthermore, the carrier main portion of a reticle carrier 140 carried to the delivery port 142 is separated from its cover in the same way as in the second embodiment, and a reticle conveying system (not shown) that includes a robot (not shown) and serves as a mask-transport system conveys a plurality of reticles, or a reticle, in the reticle carrier 140 along a path indicated by an arrow B in FIG. 15B, and stores them in a reticle store portion (not shown) inside the exposure-apparatus main body 12. And a reticle loader (not shown) transfers the reticles between the reticle store portion and a reticle stage RST.

Meanwhile, after tasks of the reticles such as exposure through them has been finished, the reticle conveying system conveys the reticles along the path in reverse to below the delivery port 142.

According to the lithography system 130 having the structure described above, for the same reason as with the second embodiment, the time necessary for the whole process of transport of reticles, which time includes a time for exchange of reticles, can be shortened compared to conveying reticle carriers 140 one by one from the outside. Therefore, the throughput can be improved.

In addition, because the delivery port 142 is provided near the front end and on the right side of the exposure-apparatus main body 12, which is much apart from the illumination optical system IOP, the reticle conveying system can be arranged near the delivery port 142. Therefore, a conveying system of an exposure apparatus of the prior art can be used as the reticle conveying system by slightly modifying.

<<A Fifth Embodiment>>

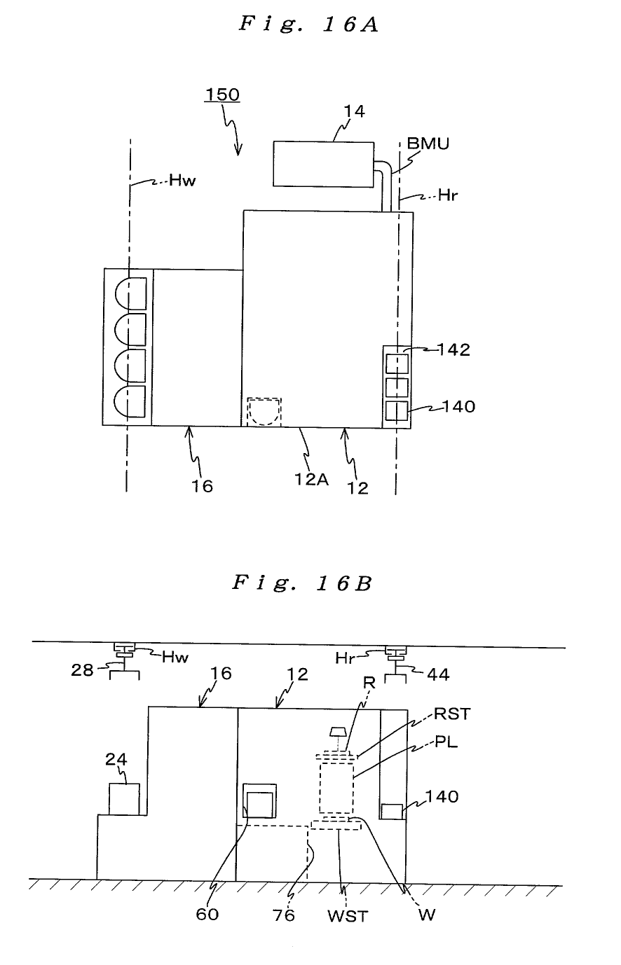

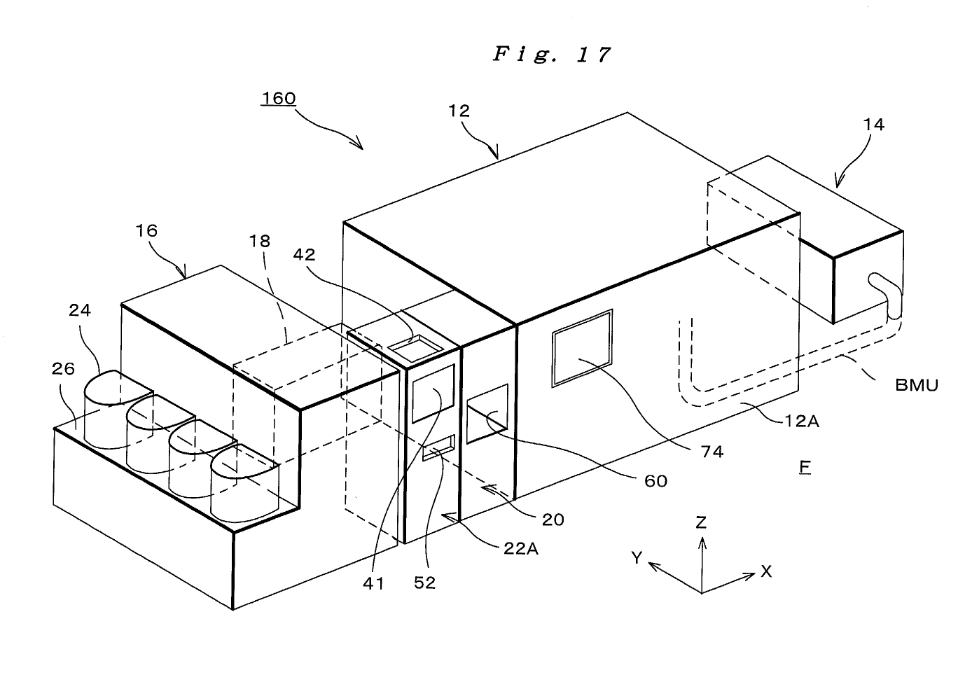

Next, a fifth embodiment of the present invention will be described below with reference to FIGS. 16A and 16B. Note that the same elements as, or equivalent elements to, those of the first and fourth embodiments are represented by the same symbols, and that brief or no descriptions about these elements will be presented.

FIG. 16A shows a plan view of a lithography system 150 according to the fifth embodiment, and FIG. 16B shows a front view of the lithography system 150.

The lithography system 150, as a whole, has the same structure as the lithography system 130 of the fourth embodiment, but is different in the following points.

That is, in the lithography system 150 a concave is formed near the front end of the right side of an environmental chamber 12A of an exposure-apparatus main body 12, and on the upper surface of the concave, as shown in FIGS. 16A and 16B, is provided an delivery port 142 on which three reticle carriers 140 as mask containers can be placed along the guide rail Hr. The structure of the other parts is the same as that of the lithography system 130 according to the fourth embodiment.

According to the lithography system 150 of the fifth embodiment, the effect equivalent to that of the fourth embodiment can be obtained, and as obviously seen by comparing FIGS. 15A and 16A, the footprint can be reduced.

Although in the second through fifth embodiments, reticles are removed from the carrier main portion separated from its cover, and transferred to the reticle store portion or the reticle stage RST, the carrier main portion containing the reticles may be transferred. In this case, when the carrier main portion has a store rack for holding a plurality of reticles, the carrier main portion can be used instead of the reticle store portion. It is noted that only one reticle may be contained in the carrier main portion. Moreover, the carrier main portion may be filled with inert gas such as helium and nitrogen or chemically clean dry-air (e.g. of humidity around or less than 5%), which is especially effective with an exposure apparatus using exposure light having a wavelength of 180 nm or less. The housing of such an exposure apparatus, in which housing a reticle stage RST is provided, includes a transport path from the carrier main portion separated from a cover to the housing itself, and inert gas is supplied to the inside of the housing.

<<A Sixth Embodiment>>

Next, a sixth embodiment of the present invention will be described below with reference to FIGS. 17 to 21. Note that the same elements as, or equivalent elements to, those of the first embodiment are represented by the same symbols, and that brief or no descriptions about these elements will be presented.

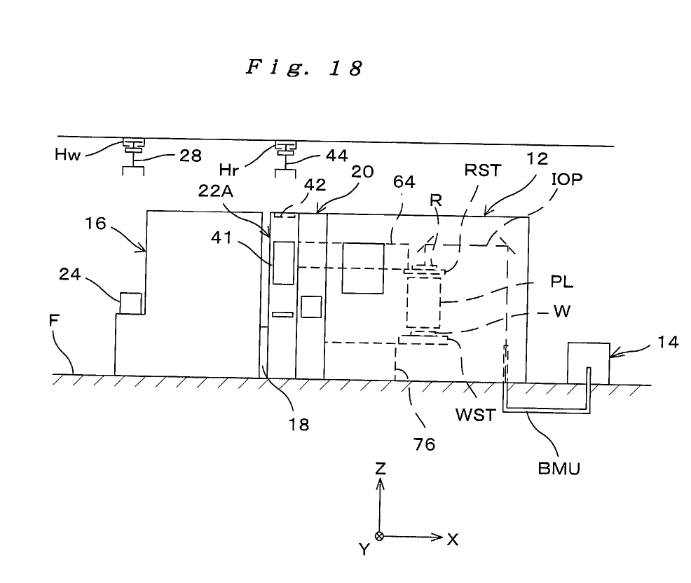

FIG. 17 shows the schematic, oblique view of a lithography system 160 of the sixth embodiment according to this invention, and FIG. 18 shows a right side view of the lithography system 160. AS seen in those Figs., The lithography system 160 is characterized in that in place of the reticle port housing 22 of the lithography system 10, the reticle port housing 22A is provided as the mask-transport-system housing.

The lithography system 160 is arranged in a clean room having a cleanness degree of about class 100 to 1000 as in the above lithography systems.

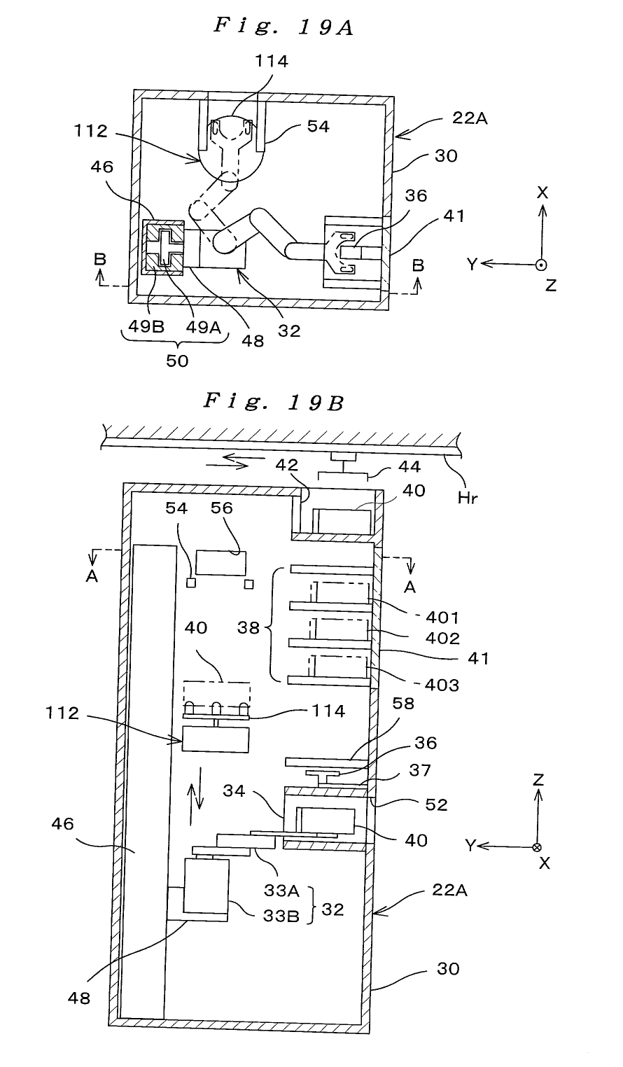

FIG. 19A shows a schematic, lateral cross-section view of the reticle port housing 22A, and FIG. 19B shows a schematic, longitudinal cross-section view of the reticle port housing 22A. FIG. 19A shows the cross-section taken along A-A line in FIG. 19B, and FIG. 19B shows the cross-section along B-B line in FIG. 19A.

In the below, the reticle port housing 22A will be described with reference to FIGS. 19A and 19B.

As obviously seen by comparing FIGS. 19A and 19B with FIGS. 4A and 4B, although basically the reticle port housing 22A has the same structure as that of the reticle port housing 22, the reticle port housing 22A is different in that a direction change unit 112 is provided inside the chamber 30 as the housing and that a window 41 constituted by a transparent member is made in the side of the chamber 30 opposite the carrier stock portion 38.

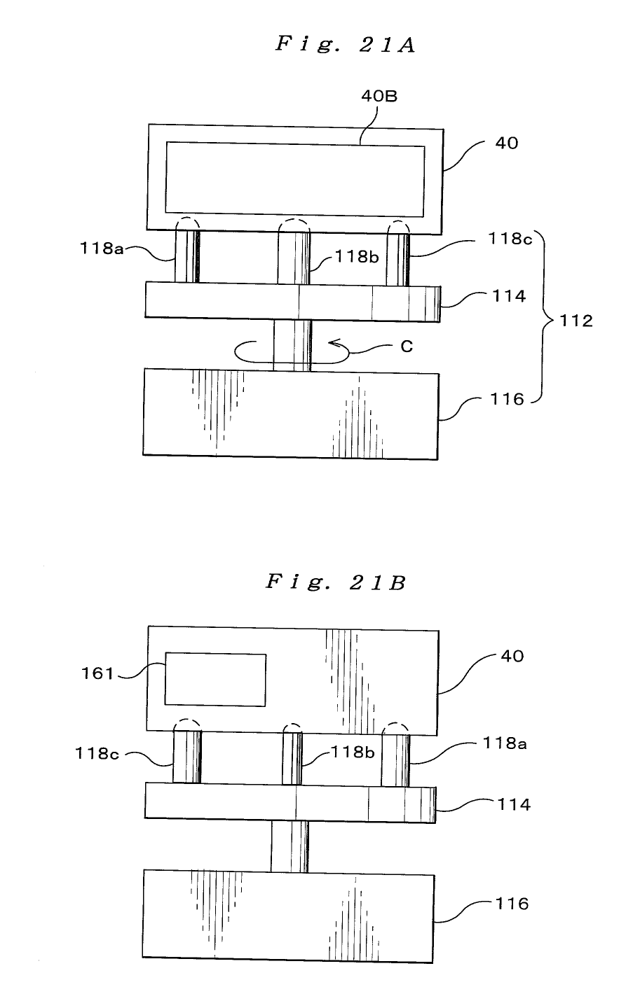

In the sixth embodiment, the reticle carrier 40 (refer to FIGS. 5A, 5B) is used as a mask container. It is remarked that a label 161 (refer to FIG. 21B) representing information concerning the reticle R in the reticle carrier is attached to the side of the container main body 40A, which side is reverse to the lid 40B, the side being referred to as a label surface.

It is noted that when an operator manually carries the reticle carrier 40 having such a label surface into the apparatus through the in-out port 52, it is preferable to put the label surface to face the front so as to be able to perform the carrying-in confirming the contents of the label.

As a result, in this embodiment, as shown in FIG. 19B, reticle carriers 40 are stored in the carrier stock portion 38 such that label surfaces thereof face the sidewall of the chamber 30. The window 41 is made in the portion of the chamber 30 opposite the label surface of the reticle carriers 40 (reticle carriers 40₁, 40₂, 40₃). Therefore, the operator can confirm the contents of the label 161 of each of the reticle carriers 40₁, 40₂, 40₃, stored in the carrier stock portion 38, through the window 41.

When the label surfaces of the reticle carriers 40 in the carrier stock portion 38 face the window 41 as in the above, the lids 40B face inwards to the reticle port housing 22A. In this case, a lid 40B cannot be pushed against the sidewall of the chamber 30 with any movement of the arm 33A of the robot 32, and cannot be opened.

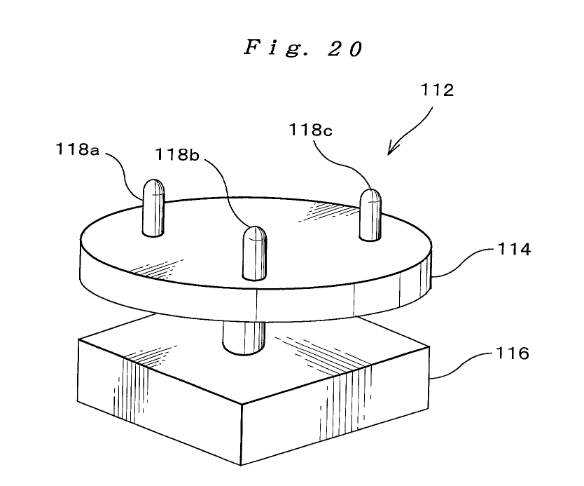

Therefore, in the sixth embodiment, a orientation-change unit 112 is disposed near the center in the height direction inside the reticle port housing 22A and below the rack 54, near the sidewall in the +X direction of the chamber 30. The orientation-change unit 112 is supported by a support member (not shown), and comprises, as shown on a larger scale in FIG. 20, a turntable 114 on which the reticle carrier 40 is mounted, and a driving mechanism 116 to turn the turntable 114. The turntable 114 is constituted by a disc-shaped member; three support members 118a to 118c sticking out from the upper surface thereof are uniformly arranged along an imaginary circle such that the distances between them are substantially equal, and support the reticle carrier 40 from below. The tips of the support members 118a to 118c are in a spherical shape, and each reticle carrier 40 has three circular-cone-shaped holes (not shown) made on the bottom surface thereof, which holes are arranged in the same positional relation as the support members 118a to 118c are. That is, in this embodiment, by the three support members 118a to 118c engaging with the circular-cone-shaped holes, the reticle carrier 40 is positioned and mounted at a predetermined position on the turntable 114.

Incidentally, a support structure of the reticle carrier 40 may be a so-called kinematic support structure where either the turntable or the reticle carrier has three spherical protrusions, and where the other has V-shaped or circular-cone-shaped holes engaging with the spherical protrusions so as to support the spherical protrusions.

Additionally, in this embodiment, as shown in FIG. 19B, the OHV 44 as a ceiling-transport system transports a reticle carrier 40 to the delivery port 42, the lid 40B of which faces inwards to the reticle port housing 22A.

The structures of the other elements are the same as those of the lithography system 10.

Next, the method of a lithography system transporting a reticle will be described briefly, which system is according to the sixth embodiment having the above structure.

First, the OHV 44 transports the reticle carrier 40 containing a reticle to the delivery port, made in the ceiling of the reticle port housing 22A, along the guide rail Hr, or an operator manually carries the reticle carrier 40 containing a reticle through the in-out port 52 to the carrier mount 34. In either case, the robot 32 stores the reticle carrier 40 in the carrier stock portion according to a predetermined setting, as the need arises.

Next, from one of the carrier mount 34, the carrier stock portion 38 and the delivery port 42, the arm 33A of the robot 32 transfers and mounts the reticle carrier 40 onto the turntable 114 of the orientation-change unit 112. FIG. 21A shows the state where the reticle carrier 40 has been mounted on the turntable 114 by the arm 33A.

Next, the driving mechanism 116 turns the turntable 114 through 180 degrees in the direction of an arrow C in FIG. 21A, such that the label 161 of the reticle carrier 40 faces inwards to the reticle port housing 22A (in the forward direction of the drawing in FIG. 21B) as shown in FIG. 21B.

After that, the arm 33A of the robot 32 transfers the reticle carrier 40 from the turntable 114 to the rack 54 for transferring a reticle to the exposure-apparatus main body 12. Next, in the same way as in the first embodiment, the lock mechanism 40C is unfastened; the lid 40B is separated from the reticle carrier 40, and the reticle from the reticle carrier 40 is transferred and stored into a reticle store portion (not shown) of the exposure-apparatus main body 12 by the reticle conveying system 64 including a robot (not shown). And a reticle loader (not shown) transfers the reticle from the reticle store portion or directly from the reticle carrier 40 onto the reticle stage RST.

As seen in the above description, the lithography system 160 and exposure apparatus thereof according to the sixth embodiment has the same effect as the first embodiment. Moreover, in the sixth embodiment, the robot 32 transfers the reticle carrier 40 between each of the carrier mount 34 having the in-out port 52, the carrier stock portion 38, and the delivery port 42 and the rack 54 where the reticle is passed to the reticle conveying system 64 for conveying to the exposure-apparatus main body 12, and the orientation-change unit 112 having the turntable 114, on which a reticle carrier 40 is mounted, and the driving mechanism 116 is provided in the transfer path. Accordingly, while transferring the reticle carrier 40 from each of the carrier mount 34, the carrier stock portion 38 and the delivery port 42 to the rack 54, the robot 32 mounts the reticle carrier 40 on the turntable 114, and turns the turntable 114 through 180 degrees via the driving mechanism 116 such that the 40B of the reticle carrier 40 faces the sidewall in the +X direction of the chamber 30. Therefore, after the change of orientation, the lid 40B can be easily separated from the main body of the reticle carrier 40 as described above, and the reticle R can be easily passed from the reticle carrier 40 to the reticle conveying system 64.

Therefore, in this embodiment, an operator can manually carry the reticle carrier 40 into the apparatus through the in-out port 52 with making the label surface face the front and confirming the contents of the label, and the reticle carrier 40 can be stored in the carrier stock portion 38 such that the label surface thereof faces the window 41, without causing any problem.

It is noted that in the sixth embodiment, although when (1) the OHV 44 transports the reticle carrier 40 to the delivery port 42, (2) it is stored in the carrier stock portion 38, and (3) it is carried in through the in-out port 52, the orientations of the reticle carrier 40 are the same, this invention is not limited to that. That is, upon at least one of (1) to (3) in the above, the orientation of the reticle carrier 40 may be reverse to that in the sixth embodiment. For example, if the orientation of the reticle carrier 40 is reverse to the above when the OHV 44 transports it to the delivery port 42, the robot 32 can transfer the reticle carrier 40 from the delivery port 42 to the rack 54 not through the orientation-change unit 112.

In addition, the position where the orientation-change unit 112 is disposed is not limited to the above. For example, the orientation-change unit 112 may be disposed in the delivery port 42 so that the OHV 44 mounts the reticle carrier 40 on the turntable 114. In this case, just after the mounting, the orientation-change unit 112 can change the orientation of the reticle carrier 40 to any direction, if necessary.

Moreover, the sixth embodiment described the case where, in either of the OHV 44 transporting the reticle carrier 40 to the delivery port 42 and an operator carrying in the reticle carrier 40 through the in-out port 52, the orientations of the reticle carrier 40 are the same predetermined orientation, where the relation between the orientation and an orientation that the reticle carrier 40 takes when it is placed in the rack 54 so as to separate from the lid 40B is known, and where, based on the relation, the angle (specifically 180° or 0°) is determined through which the turntable 114 is rotated. However, this invention is not limited to that.

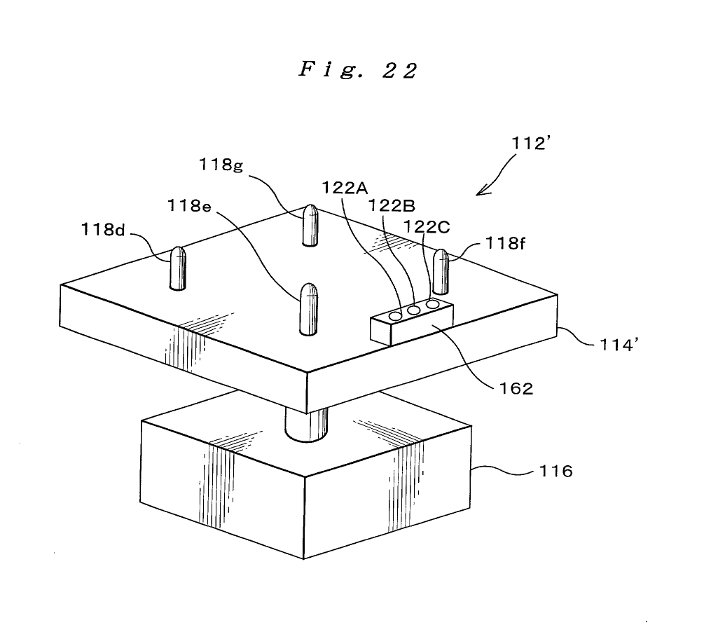

For example, in the case where an orientation-change unit comprises an orientation-detection mechanism of detecting the orientation of the reticle carrier 40, a driving mechanism may determine the angle through which the turntable 114 is rotated, based on the detection results of the orientation-detection mechanism. FIG. 22 shows a schematic view of an example of an orientation-change unit comprising such an orientation-detection mechanism. This orientation-change unit 112′ comprises a square-plate-shaped turn table 114′ instead of the turntable 114, and an orientation-detection mechanism 162 is fixed on an end of the upper surface of the turntable 114′. And four support members 118d, 118d, 118f, 118g are arranged on diagonal lines of the upper surface of the turntable 114′ so as to be spaced the same distance apart. That is, the four support members 118d, 118d, 118f, 118g form the corner points of an imaginary square smaller than the turntable 114′.

The orientation-detection mechanism 162 comprises three reflection-type photo-sensors, e.g. photo-coupler, 122A, 122B, 122C, which are arranged a predetermined distance apart from each other.

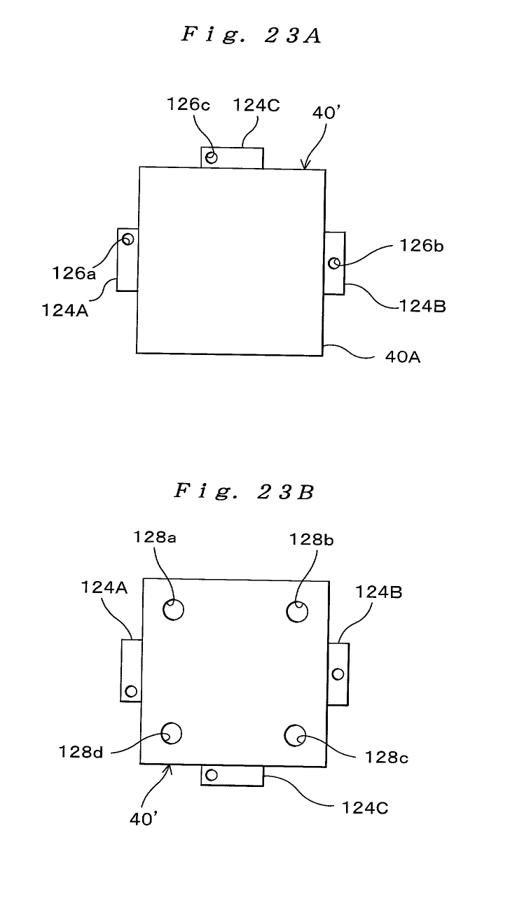

A reticle carrier 40′ having a shape shown in a plan view of FIG. 23A is suitable for the orientation-change unit 112′ shown in FIG. 22. Although this reticle carrier 40′ has basically the same structure as the reticle carrier 40 has, a protrusion 124A, 124B, 124C is provided on each of three different sides from the lid 40B's side of the carrier main body 40A, each of the protrusions having substantially the same length as the orientation-detection mechanism 162 and being located at a position that would be opposite the orientation detection mechanism 162. On the bottom surface of the reticle carrier 40′, as shown in FIG. 23B, circular-cone-shaped holes 128a, 128b, 128c, 128d are made in the same positional relation as the four support members 118d, 118d, 118f, 118g are. Accordingly, the four support members 118d, 118d, 118f, 118g engage with circular-cone-shaped holes 128a, 128b, 128c, 128d so that the reticle carrier 40′ is positioned and mounted at a predetermined position on the turntable 114′. In this case, the reticle carrier 40′ can be placed on the turntable 114′ in any of the four orientations, in three (first to third orientations) of which a protrusion 124A, 124B, 124C faces the orientation-detection mechanism 162, and in the other (fourth orientation) of which no protrusion faces the orientation-detection mechanism 162.

An opening 126a is made in a position on the protrusion 124A opposite the photo-coupler 122A when the reticle carrier 40′ is placed on the turntable 114′ in the first orientation; an opening 126b is made in a position on the protrusion 124B opposite the photo-coupler 122B when the reticle carrier 40′ is placed on the turntable 114′ in the second orientation, and an opening 126c is made in a position on the protrusion 124C opposite the photo-coupler 122C when the reticle carrier 40′ is placed on the turntable 114′ in the third orientation.

When the reticle carrier 40′ is placed on the turntable 114′, a controller (not shown) embedded in the driving mechanism 116 can find the orientation of the reticle carrier 40′ on the turntable 114′ by checking via the orientation-detection mechanism 162 whether only the photo-coupler 122A detects reflected light, whether only the photo-coupler 122B detects reflected light, whether only the photo-coupler 122C detects reflected light, or whether no photo-coupler detects reflected light. Therefore, the driving mechanism 116 can change the orientation of the reticle carrier 40′ to be suitable for passing a reticle R in the rack 54 by rotating the turntable 114′ through 0°, 90°, 180° or 270° depending on the detected orientation of the reticle carrier 40′, even if the orientation of the reticle carrier 40′ carried to the delivery port 42, etc., is random. Accordingly, no restriction needs to be set on the orientation of the reticle carrier 40′ upon the carrying-in.

It is remarked that although the sixth embodiment described the case where the front-open-type and sealed-type reticle carrier 40 is used as a mask container, this invention is not limited to that. A sealed-type container may be used such as a SMIF (Standard Mechanical Interface) pod, which is described in the second to fifth embodiments.

In addition, it is remarked that although the sixth embodiment described the case where the orientation-change unit 112 is arranged inside the reticle port housing 22A, this invention is not limited to that. The orientation-change mechanism for changing the orientation of the reticle carrier 40 (or 40′) may be disposed on, for example, the OHV 44 for transporting the reticle carrier 40 (or 40′) to the delivery port 42 of the reticle port housing 22A.

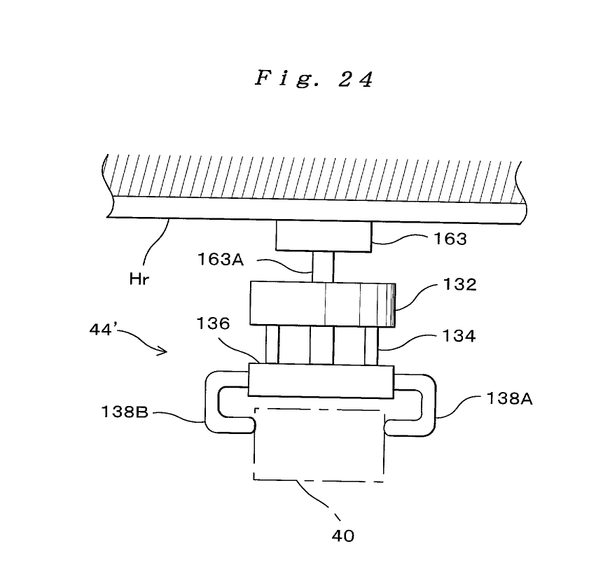

FIG. 24 shows a schematic view of an exemplary OHV comprising such an orientation-change mechanism. An OHV 44′ in FIG. 24 comprises a slide-turn mechanism 163; a cylinder-shaped belt support member 132 attached to the rotation axis 163A of the slide-turn mechanism 163; three belts 134 hanging from the belt-support member 132; an attaching member 136 provided on the lower ends of the belts 134; and a pair of claws 138A, 138B that are provided on the attaching member 136 and that are displaceable in a sliding manner.

Inside the belt-support member 132, a hoist is embedded that hoists and lowers the three belts simultaneously, and the attaching member 136 and claws 138A, 138B as one piece are moved up and down by the hoist. Moreover, inside the attaching member 136, a driving mechanism is embedded that moves the claws 138A, 138B such that the distance between them changes. Therefore, the reticle carrier 40 is firmly held by the pair of claws 138A, 138B.

While the OHV 44′ having such structure moves along the guide rail Hr and transports the reticle carrier 40, the slide-turn mechanism 163 changes the orientation of the reticle carrier 40 to be suitable for, in the rack 54, passing a reticle R to the reticle conveying system 64. Therefore, regardless of the orientation at the start of the transport by the OHV 44′, the orientation of the reticle carrier can be changed to be suitable for, in the rack 54, passing a reticle R to the reticle conveying system 64.

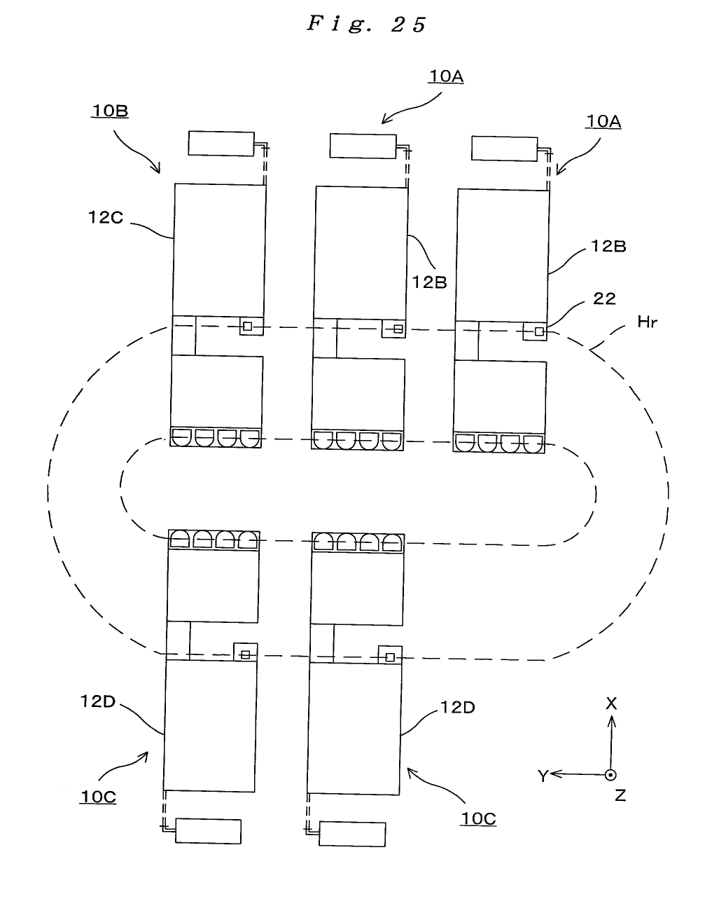

Moreover, even if a plurality of lithography systems 10A, 10B, 10C each of which comprises plural kinds of exposure apparatuses 12B, 12C, 12D, which are from different makers and which have different specifications, are arranged in the same clean room as shown in FIG. 25, it is possible to transport a reticle carrier to any of the exposure apparatuses, setting the orientation of the reticle carrier to be suitable for the exposure apparatus, because the slide-turn mechanism 163 provided on the OHV 44′ moving along the guide rail Hr extending on the ceiling sets the orientation in the way described above during the transport. Therefore, even if a plurality of exposure apparatuses 12B, 12C, 12D, which are from different makers and which have different specifications, are arranged in the same clean room, it is possible to transport a reticle contained in a reticle carrier to each of the exposure apparatuses by the same ceiling-transport system, setting the orientation of the reticle carrier to be suitable for the exposure apparatus.

In this case, as the simplest method, the slide-turn mechanism 163 may has information regarding respective orientations suitable for exposure apparatuses 12B, 12C, 12D stored in memory thereof so that the orientation of the reticle carrier is set according to which exposure apparatus the reticle carrier is transported to. Or the slide-turn mechanism 163 may set the orientation of the reticle carrier according to instructions from a host computer controlling all lithography systems in the clean room.

Furthermore, a communication unit (transmitter-receiver) may be provided that provides communication between the exposure apparatuses 12B, 12C, 12D and the OHV 44′, and based on communication results, the orientation of the reticle carrier may be set. In this case, it is possible to pass a reticle carrier to each of the exposure apparatuses, setting the orientation of the reticle carrier to be suitable for the exposure apparatus, regardless of the orientation of the reticle carrier containing a reticle during the transport by the OHV 44′.

In addition, although the above described the orientation change of the reticle carrier as a mask container, the application is not limited to that. FOUP as a wafer container may also be changed in orientation. For example, it is obvious that, using the same ceiling-transport system as the OHV 44′ as a transport system for FOUP, the orientation of FOUP can be easily changed during the transport. Additionally, even if a FOUP in any orientation is carried in through the FOUP extension port, by arranging an orientation-change mechanism of the same principle as that of the orientation-change mechanism 112 inside, e.g., the FOUP extension housing 20, it is possible to set the orientation of the FOUP to be suitable for passing a wafer to the exposure-apparatus main body. Or a FOUP mount on which a FOUP is mounted may be constructed to be rotatable.

It is noted that although a lithography system of the sixth embodiment and the lithography system in FIG. 25 described the case where the delivery port 42 that can receive only one the reticle carrier is provided on the ceiling portion of the reticle port housing 22A (or 22) (refer to FIGS. 17, 25), this invention is not limited to that. For example, on the ceiling portion of the reticle port housing 22A (or 22) (or on the ceiling portion of the C/D 16), a delivery port that can hold a plurality of mask containers along the guide rail Hr may be provided that is the same as the delivery port 142 used in the second to fifth embodiments. In this case, when providing such an orientation-change mechanism on the delivery port that can hold a plurality of mask containers along the guide rail Hr, it is preferable that the orientation-change mechanism can change the orientation of each mask containers to any direction. Or, needless to say, the same slide-turn mechanism as the slide-turn mechanism 163 may be provided on the OHV as a ceiling-transport system. In the case of providing a slide-turn mechanism on the ceiling-transport system, the slide-turn mechanism may set the orientation of the reticle carrier according to information, stored beforehand, of orientation suitable for the exposure apparatus during carrying in the reticle carrier, according to instructions from the host computer, or according to communication results with the exposure apparatus.

It is remarked that although in the above embodiments (including modified examples) a sealed-type reticle carrier (40, 40′, 140, etc.) comprising a open-close lid 40B is used as a mask container, and a sealed-typer FOUP 24 comprising a open-close lid 25 is used as a substrate container, that is because using these containers can prevent dust, etc., from entering the container (the reticle carrier or the FOUP) even if the cleanness degree of the clean room is as low as class 100 to 1000, and thus the cost of the clean room is reduced. However, this invention is not limited to that. For example, when a lithography system is provided in the clean room having the cleanness degree as high as class 1, an open-type carrier may be used as the substrate container, and an open-type reticle carrier as the mask container.

In addition, in lithography systems of the above embodiments, because a C/D 16 is used as the substrate-processing unit, the sequence of resist coating, exposure and development in the lithography process can be performed under circumstances free from dust. However, this invention is not limited to that. A lithography system according to this invention can be constructed by connecting a coater (resist coating unit) and developer (development unit) that are parts of the substrate-processing unit in-line with the exposure-apparatus main body.

Moreover, in the above embodiments, a pulse laser light source such as ArF excimer laser, F₂ laser or Ar₂ laser is used as the laser unit 14 that is a light source for the exposure apparatus. An exposure apparatus and lithography system according to this invention is not limited to this, needless to say. For example, the laser unit as a light source may be a YAG laser unit using a harmonic wave as exposure light, a laser plasma unit generating EUV light in the soft X-ray range of wavelength 5 to 15 nm by illuminating EUV light generation material such as a copper tape with laser light, SOR or a high power laser using semiconductor laser excitation.

In addition, the light source, i.e. illumination light for exposure, of an exposure apparatus of this invention is not limited to those. This invention can be applied to, for example, a DUV exposure apparatus employing as exposure light far-ultraviolet light (DUV) such as an ultraviolet-emission line (g-line, i-line, etc.) of an ultra-high pressure mercury lamp, a VUV exposure apparatus employing vacuum-ultraviolet light (VUV) such as ArF excimer laser light, F₂ laser light or Ar₂ laser light, a X-ray exposure apparatus and an electron-beam exposure apparatus, which are connected in-line with the substrate-processing unit such as C/D 16.

Furthermore, as a vacuum ultraviolet light other than ArF excimer laser light or F₂ laser light, a higher harmonic wave may be used which is obtained with wavelength conversion into ultraviolet by using non-linear optical crystal after having amplified a single wavelength laser light, infrared or visible, emitted from a DFB semiconductor laser device or a fiber laser by a fiber amplifier having, for example, erbium (or erbium and ytterbium) doped.

Needless to say, the present invention can be applied not only to a wafer exposure apparatus used in the manufacture of semiconductor devices but also to an exposure apparatus that transfers a device pattern onto a glass plate and that is used in the manufacture of displays such as liquid crystal display devices, an exposure apparatus that transfers a device pattern onto a ceramic plate and that is used in the manufacture of thin magnetic heads, and an exposure apparatus used in the manufacture of pick-up devices (CCD, etc.) or micromachines.

Moreover, the present invention can be applied not only to an exposure apparatus for producing micro devices such as semiconductor devices but also to an exposure apparatus that transfers a circuit pattern onto a glass substrate or silicon wafer so as to produce reticles or masks used by a light exposure apparatus, EUV (Extreme Ultraviolet) exposure apparatus, X-ray exposure apparatus, electron beam exposure apparatus, etc. Incidentally, in an exposure apparatus using DUV (far ultraviolet) light or VUV (vacuum ultraviolet) light, a transmission-type reticle is employed in general. And as the substrate of the reticle, quartz glass, quartz glass with fluorine doped, fluorite, magnesium fluoride, or quartz crystal is employed. And an X-ray exposure apparatus of a proximity method or electron beam exposure apparatus employs a transmission-type mask (stencil-mask, membrane-mask), and as the substrate of the mask, silicon wafer or the like is employed.

Moreover, the scale of the projection optical system is not limited to a reduced scale and may be an equal or magnified scale. Furthermore, in the projection optical system, quartz or fluorite may be used as the glass material when an excimer laser is employed, and the optical system and reticle are of a reflection type when EUV light is employed.

In addition, the structures of the exposure-apparatus main body 12 and conveying systems provided in the housings 20, 22 are not limited to those of the above embodiments.

An exposure apparatus of the embodiment can be made in the following manner. The illumination optical system (IOP) and the projection optical system (PL), which are constituted of a plurality of lenses, are built in the housing of the exposure apparatus, and optical adjustment is performed thereto; the reticle stage RST and the wafer stage WST that consist of a number of mechanical parts are installed in the housing of the exposure apparatus and are connected with electric wires and pipes, and then overall adjustment (electrical adjustment, operation check and the like) is performed. Incidentally, it is preferable that the exposure apparatus is made in a clean room where temperature, cleanness and the like are controlled.

<<A Device Manufacturing Method>>

Next, an embodiment of the method of manufacturing devices using a lithography system and exposure apparatus thereof according to the above embodiments will be described.

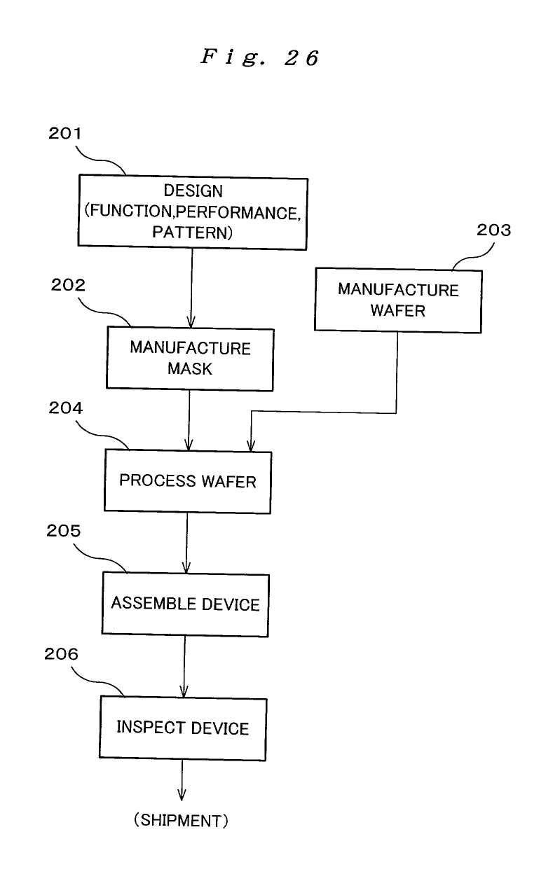

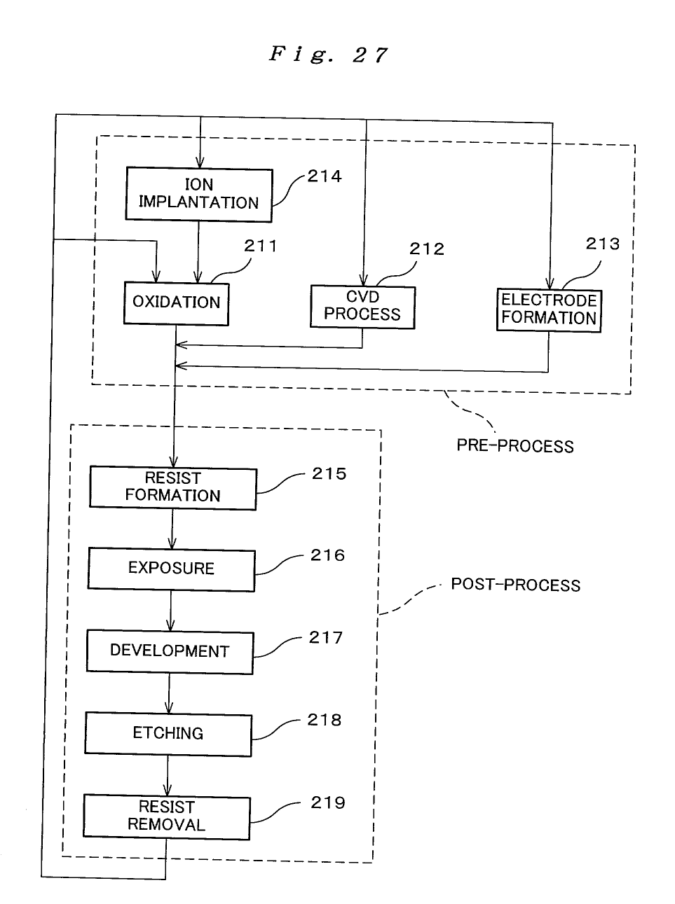

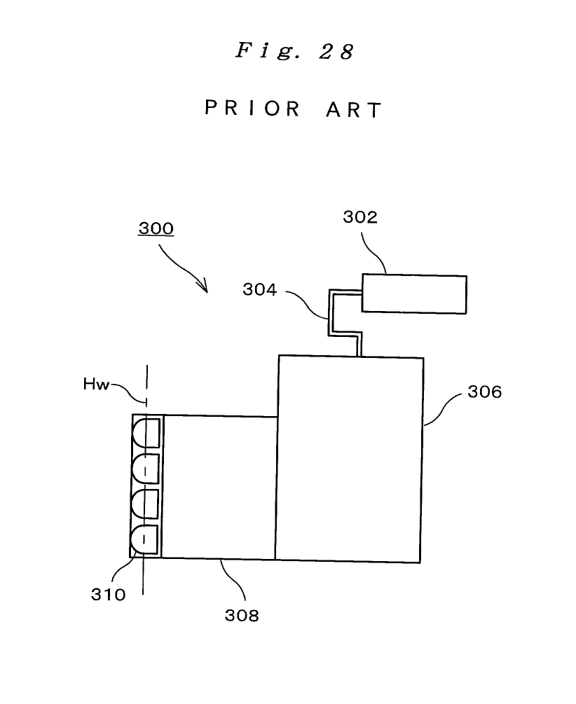

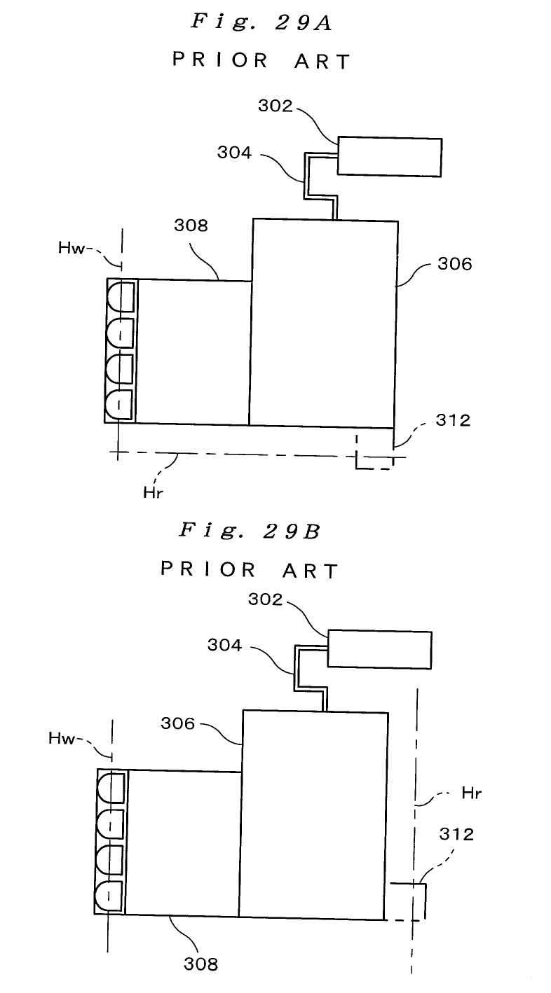

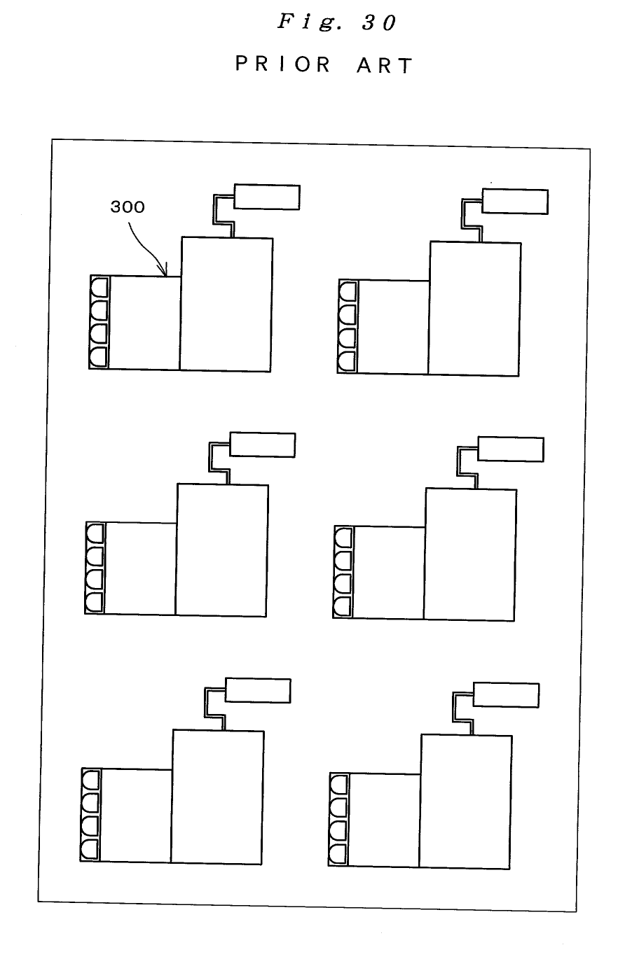

FIG. 26 is a flow chart for the manufacture of devices (semiconductor chips such as IC or LSI, liquid crystal panels, CCD's, thin magnetic heads, micro machines, or the like) in this embodiment. As shown in FIG. 26, in step 201 (design step), function/performance design for the devices (e.g., circuit design for semiconductor devices) is performed and pattern design is performed to implement the function. In step 202 (mask manufacturing step), masks on which a different sub-pattern of the designed circuit is formed are produced. In step 203 (wafer manufacturing step), wafers are manufactured by using silicon material or the like.

In step 204 (wafer processing step), actual circuits and the like are formed on the wafers by lithography or the like using the masks and the wafers prepared in steps 201 through 203, as will be described later. In step 205 (device assembly step), the devices are assembled from the wafers processed in step 204. Step 205 includes processes such as dicing, bonding, and packaging (chip encapsulation).

Finally, in step 206 (inspection step), a test on the operation of each of the devices, durability test, and the like are performed. After these steps, the process ends and the devices are shipped out.

FIG. 27 is a flow chart showing a detailed example of step 204 described above in manufacturing semiconductor devices. Referring to FIG. 27, in step 211 (oxidation step), the surface of a wafer is oxidized. In step 212 (CVD step), an insulating film is formed on the wafer surface. In step 213 (electrode formation step), electrodes are formed on the wafer by vapor deposition. In step 214 (ion implantation step), ions are implanted into the wafer. Steps 211 through 214 described above constitute a pre-process for each step in the wafer process and are selectively executed in accordance with the processing required in each step.

When the above pre-process is completed in each step in the wafer process, a post-process is executed as follows. In this post-process, first of all, in step 215 (resist formation step), the wafer is coated with a photosensitive material (resist). In step 216, the above exposure apparatus transfers a sub-pattern of the circuit on a mask onto the wafer according to the above method. In step 217 (development step), the exposed wafer is developed. In step 218 (etching step), an exposing member on portions other than portions on which the resist is left is removed by etching. In step 219 (resist removing step), the unnecessary resist after the etching is removed.

By repeatedly performing these pre-process and post-process, a multiple-layer circuit pattern is formed on each shot-area of the wafer.

According to the device manufacturing method of this embodiment described above, in the exposure step (step 216), the lithography system and exposure apparatus according to any of the above embodiments are used, and therefore it is possible to manufacture highly-integrated devices with high yield when ArF excimer laser unit or F₂ laser unit is used as the laser unit. Furthermore, as described above, in a lithography system and exposure apparatus according to any of the above embodiments, because the efficiency in using the space of a clean room is improved, the manufacturing cost of devices can be reduced. Therefore, the productivity of highly integrated micro-devices can be improved overall.

As described above, an exposure apparatus and lithography system according to this invention are suitable to reduce equipment cost in the lithography process of manufacturing micro-devices such as integrated circuits. In addition, a conveying method according to this invention is suitable to transport a mask container and substrate container. Furthermore, the device manufacturing method according to this invention is suitable to improve the productivity of devices having a fine pattern and to reduce the manufacture cost.

While the above-described embodiments of the present invention are the presently preferred embodiments thereof, those skilled in the art of lithography systems will readily recognize that numerous additions, modifications, and substitutions may be made to the above-described embodiments without departing from the spirit and scope thereof. It is intended that all such modifications, additions, and substitutions fall within the scope of the present invention, which is best defined by the claims appended below.

What is claimed is:

1. An exposure apparatus used in a lithography process, said exposure apparatus comprising:
an exposure-apparatus main body provided on a floor surface;
a laser unit, as an exposure light source, arranged in an area of said floor surface, the width of said area being defined by maintenance areas, on both sides of said exposure-apparatus main body, inclusive.

2. An exposure apparatus according to claim 1, wherein said exposure-apparatus main body and said laser unit are so arranged on said floor surface that maintenance areas of said exposure-apparatus main body and said laser unit overlap each other at least partially.

3. An exposure apparatus according to claim 2, wherein said exposure-apparatus main body and said laser unit are so arranged on said floor surface that a whole maintenance area of said laser unit is included in a maintenance area of said exposure-apparatus main body.

4. An exposure apparatus according to claim 1, wherein a housing of said laser unit is arranged on said floor surface and adjacent to a housing of said exposure-apparatus main body.

5. An exposure apparatus according to claim 1, wherein a housing of said laser unit is directly connected to a housing of said exposure-apparatus main body.

6. An exposure apparatus according to claim 1, wherein said laser unit is connected through a guide optical system to said exposure-apparatus main body.

7. An exposure apparatus according to claim 6, wherein said guide optical system is arranged below a floor surface on which said exposure-apparatus main body is provided.

8. An exposure apparatus according to claim 1, wherein a substrate-processing unit can be connected in-line with a side of said exposure-apparatus main body reverse to said laser unit.

9. An exposure apparatus according to claim 8, wherein said substrate-processing unit can be connected through an inline-interface portion with said exposure-apparatus main body.

10. An exposure apparatus according to claim 9, wherein said inline-interface portion is detachable from said exposure-apparatus main body.

11. An exposure apparatus according to claim 9, wherein said exposure-apparatus main body and said laser unit are so arranged on said floor surface that maintenance areas of said exposure-apparatus main body and said laser unit overlap each other at least partially.

12. An exposure apparatus according to claim 8, wherein, near the end surface of a side of said exposure-apparatus main body, to which side said substrate-processing unit is connected, a delivery port is arranged to and from which a mask container containing a mask is transported by a ceiling-transport system that moves along a rail extending on a ceiling opposite to said floor surface.

13. An exposure apparatus according to claim 12, wherein, said mask container is a sealed-type container having a lid that can be opened and closed.

14. A lithography system comprising:
an exposure apparatus according to claim 1; and
a substrate-processing unit that is arranged on a side of, said exposure-apparatus main body, reverse to said laser unit and is connected in-line with said exposure-apparatus main body.

15. A lithography system according to claim 14, wherein said substrate-processing unit is a coater-developer.

16. A device manufacturing method including a lithography process, wherein in said lithography process, exposure is performed using an exposure apparatus according to claim 1.

17. An exposure apparatus used in a lithography process, said exposure apparatus comprising:
an exposure-apparatus main body provided on a floor surface;
a laser unit as an exposure light source, which is so arranged on said floor surface that a maintenance area of said exposure-apparatus main body and a maintenance area of said laser unit overlap each other at least partially.

18. An exposure apparatus according to claim 17, wherein said exposure-apparatus main body and said laser unit are so arranged on said floor surface that a whole maintenance area of said laser unit is included in a maintenance area of said exposure-apparatus main body.

19. An exposure apparatus according to claim 17, wherein said exposure-apparatus main body and said laser unit are arranged in-line along a longitudinal direction of said exposure-apparatus main body on said floor surface.

20. An exposure apparatus according to claim 17, wherein a housing of said laser unit is arranged on said floor surface and adjacent to a housing of said exposure-apparatus main body.

21. An exposure apparatus according to claim 17, wherein a housing of said laser unit is directly connected to a housing of said exposure-apparatus main body.

22. An exposure apparatus according to claim 21, wherein said laser unit is so arranged on said floor surface that a longitudinal direction of said laser unit coincides with a longitudinal direction of said exposure-apparatus main body.

23. An exposure apparatus according to claim 22, wherein said laser unit is any one of an ArF excimer laser unit having an oscillation wavelength of 193 nm, a F₂ laser unit and a laser plasma unit.

24. An exposure apparatus according to claim 17, wherein said laser unit is connected through a guide optical system to said exposure-apparatus main body.

25. An exposure apparatus according to claim 24, wherein said guide optical system is arranged below a floor surface on which said exposure-apparatus main body is provided.

26. A lithography system comprising:
an exposure apparatus according to claim 17; and
a substrate-processing unit that is arranged on a side of, said exposure-apparatus main body, reverse to said laser unit and is connected in-line with said exposure-apparatus main body.

27. A lithography system according to claim 26, wherein said substrate-processing unit is a coater-developer.

28. A device manufacturing method including a lithography process, wherein in said lithography process, exposure is performed using an exposure apparatus according to claim 17.

29. An exposure apparatus connected in-line with a substrate-processing unit, said exposure apparatus comprising:
an exposure-apparatus main body that transfers a pattern of a mask onto a substrate through a projection optical system and to the front surface of which said substrate-processing unit can be connected, said front surface being an end surface in a longitudinal direction of said exposure-apparatus main body, and
wherein, in a side of said exposure-apparatus main body, which side is in front of an optical axis of said projection optical system and to which side said substrate-processing unit is connected, a delivery port is arranged into and from which said mask contained in a mask container is loaded and unloaded by a ceiling-transport system that moves along a rail extending on a ceiling opposite to said floor surface on which said exposure-apparatus main body is provided.

30. An exposure apparatus according to claim 29, wherein said exposure-apparatus main body can be connected with an end of an inline-interface portion, another end of which is connected with said substrate-processing unit.

31. An exposure apparatus according to claim 30, wherein said end of said inline-interface portion is detachable from said exposure-apparatus main body.

32. An exposure apparatus according to claim 29, wherein at least two mask containers that are the same as said mask container can be placed along a rail of said ceiling-transport system in said delivery port.

33. An exposure apparatus according to claim 29, wherein said delivery port is arranged at a height of about 900 mm from a floor surface.

34. An exposure apparatus according to claim 29, wherein a laser unit as an exposure light source is connected to an end surface of said exposure-apparatus main body reverse to said front surface to which said substrate-processing unit is connected.

35. An exposure apparatus according to claim 34, wherein said laser unit is attended by an illumination optical system.

36. A device manufacturing method including a lithography process, wherein in said lithography process, exposure is performed using an exposure apparatus according to claim 29.

37. An exposure apparatus comprising:
an exposure-apparatus main body that transfers a pattern of a mask onto a substrate;
a mask-container storeroom having a carrying-in port, for a mask container, into which said mask contained in a mask container is carried;
a transport mechanism that transports said mask container carried in between said carrying-in port and a position in which to deliver a mask to a conveying system of said exposure-apparatus main body side; and
an orientation-change unit that is arranged in part of a path of said transport mechanism transporting said mask container and changes the orientation of said mask container.

38. An exposure apparatus according to claim 37, wherein said orientation-change unit comprises a turntable on which said mask container is mounted, and a driving mechanism that rotates said turntable.

39. An exposure apparatus according to claim 38, wherein said orientation-change unit is arranged on the ceiling of said mask-container storeroom.

40. An exposure apparatus according to claim 38, further comprising:
an orientation-detection mechanism that detects the orientation of said mask container mounted on said turntable, and
wherein said driving mechanism sets an angle through which said turntable is to be rotated, based on detection results of said orientation-detection mechanism.

41. An exposure apparatus according to claim 37, wherein said turntable has a kinematic support structure that supports said mask container at a point, line and plane.

42. An exposure apparatus according to claim 37, wherein said carrying-in port is a delivery port which is provided on the ceiling of said mask-container storeroom, and to which said mask container is delivered by a ceiling-transport system transporting said mask contained said mask container.

43. An exposure apparatus according to claim 42, wherein at least two mask containers that are the same as said mask container can be placed in-line along a rail of said ceiling-transport system in said delivery port.

44. An exposure apparatus according to claim 43, wherein said orientation-change unit changes individually orientations of mask containers that are placed in said delivery port.

45. An exposure apparatus according to claim 37, wherein said carrying-in port is an in-out port provided in a side surface of said mask-container storeroom.

46. An exposure apparatus according to claim 37, wherein said mask container has an opening, and said orientation-change unit changes the orientation of said mask container according to the direction of said opening.

47. An exposure apparatus according to claim 46, wherein said mask container has a lid that can close said opening.

48. A lithography system used in a clean room comprising:
an exposure apparatus that is provided on a floor surface of said clean room and transfers a pattern of a mask onto a substrate through a projection optical system;
a substrate-processing unit that is arranged on the front side of said exposure apparatus on said floor surface and is connected in-line with said exposure apparatus, said front side being seen in a longitudinal direction of said exposure apparatus; and
a first ceiling-transport system that moves along a first rail extending in a predetermined direction on a ceiling of said clean room, and
wherein between an optical axis of said projection optical system and said substrate-processing unit, a delivery port is arranged into and from which said mask contained in a mask container is loaded and unloaded by said first ceiling-transport system.

49. A lithography system according to claim 48, further comprising:
a second ceiling-transport system that moves along a second rail extending parallel to said first rail on said ceiling and transports said substrate contained in a substrate container from and to said substrate-processing unit.

50. A lithography system according to claim 49, wherein said first and second rails extend in a direction substantially perpendicular to the longitudinal direction of said exposure apparatus.

51. A lithography system according to claim 50, wherein at least two mask containers that are the same as said mask container can be placed in-line along said first rail in said delivery port.

52. A lithography system according to claim 49, wherein said substrate container is a sealed-type container having a lid that can be opened and closed.

53. A lithography system according to claim 48, wherein maintenance of said exposure apparatus can be performed from at least both sides thereof.

54. A lithography system according to claim 48, further comprising:
an inline-interface portion that is arranged between said exposure apparatus and said substrate-processing unit and that connects the both.

55. A lithography system according to claim 54, further comprising:
a mask-transport-system housing that is arranged parallel to said inline-interface portion and has said mask-transport system therein, and
wherein said delivery port is arranged on the ceiling of a mask-transport-system housing.

56. A lithography system according to claim 55, wherein said first rail extends in a direction substantially perpendicular to the longitudinal direction of said exposure apparatus, and
wherein at least two mask containers that are the same as said mask container can be placed in-line along said first rail in said delivery port.

57. A lithography system according to claim 55, wherein one side of said mask-transport-system housing is in the substantially same plane as one side of said exposure apparatus is, and wherein a in-out port for said mask container is provided in said one side of said mask-transport-system housing.

58. A lithography system according to claim 55, further comprising:
a substrate-container-extension housing that is arranged adjacent to said mask-transport-system housing and parallel to said inline-interface portion and has an extension port for a substrate container containing said substrate.

59. A lithography system according to claim 58, wherein one side of said substrate-container-extension housing is in the substantially same plane as one side of said exposure apparatus and one side of said mask-transport-system housing are, wherein an extension port for said substrate container is provided in said one side of said substrate-container-extension housing, and wherein an in-out port for said mask container is provided in said one side of said mask-transport-system housing.

60. A lithography system according to claim 59, wherein said extension port and said in-out port are arranged at the same predetermined height from a floor surface.

61. A lithography system according to claim 55, wherein said mask-transport system inside said mask-transport-system housing transports said mask container that was carried in by said first ceiling-transport system between said delivery port and said position in which to deliver a mask to a conveying system of said exposure apparatus side, further comprising:
an orientation-change unit that changes the orientation of said mask container to be suitable to deliver a mask to said conveying system of said exposure apparatus side in said delivery position before the transport of said mask container to said delivery position.

62. A lithography system according to claim 61, wherein said orientation-change unit changes the orientation of said mask container during transport by said first ceiling-transport system.

63. A lithography system according to claim 61, wherein said orientation-change unit changes the orientation of said mask container while said mask is transported by a conveying system in said mask-transport-system housing.

64. A lithography system according to claim 55, wherein said mask-transport-system housing is detachable.

65. A lithography system according to claim 54, further comprising:
a substrate-container-extension housing that is arranged parallel to said inline-interface portion and has an extension port for a substrate container containing said substrate.

66. A lithography system according to claim 65, wherein one side of said substrate-container-extension housing is in the substantially same plane as one side of said exposure apparatus is, and wherein an extension port for said substrate container is provided in said one side of said substrate-container-extension housing.

67. A lithography system according to claim 66, wherein an in-out port for said mask container is provided on said one side of said exposure apparatus.

68. A lithography system according to claim 67, wherein said extension port and said in-out port are arranged at the same predetermined height from a floor surface.

69. A lithography system according to claim 65, wherein said substrate-container-extension housing is detachable.

70. A lithography system according to claim 54, wherein said inline-interface portion is detachable.

71. A lithography system according to claim 48, wherein a laser unit as an exposure light source is connected to an end surface of said exposure apparatus reverse to said front surface to which said substrate-processing unit is connected.

72. A lithography system according to claim 71, wherein said laser unit is attended by an illumination optical system.

73. A lithography system according to claim 48, wherein said delivery port is arranged at a height of about 900 mm from a floor surface.

74. A lithography system according to claim 48, wherein said mask container is a sealed-type container having a lid that can be opened and closed.

75. A lithography system according to claim 74, wherein said mask container is a bottom-open-type and sealed-type container.

76. A device manufacturing method including a lithography process, wherein in said lithography process, a lithography system according to claim 48 is used.

77. A lithography system used in a clean room comprising:
an exposure apparatus that is provided on a floor surface of said clean room and transfers a pattern of a mask onto a substrate through a projection optical system;
a substrate-processing unit that is connected in-line with said exposure apparatus; and
a first ceiling-transport system that moves along a first rail extending in a predetermined direction on a ceiling of said clean room, and
wherein below said first rail, a delivery port is arranged into and from which said mask contained in a mask container is loaded and unloaded by said first ceiling-transport system, and on which at least two mask containers can be placed along said first rail.

78. A lithography system according to claim 77, further comprising:
a second ceiling-transport system that moves along a second rail extending parallel to said first rail on said ceiling and transports said substrate contained in a substrate container from and to said substrate-processing unit.

79. A lithography system according to claim 78, wherein said substrate container is a sealed-type container having a lid that can be opened and closed.

80. A lithography system according to claim 77, wherein said delivery port is provided in said exposure apparatus.

81. A lithography system according to claim 77, further comprising:
a mask-transport-system housing in which a conveying system for a mask contained said mask container is provided, and
wherein said delivery port is provided in said mask-transport-system housing.

82. A lithography system according to claim 81, wherein said mask-transport system inside said mask-transport-system housing transports said mask container that was carried in by said first ceiling-transport system from said delivery port to said position in which to deliver a mask to a conveying system of said exposure apparatus side, further comprising:
an orientation-change unit that changes the orientation of said mask container to be suitable to deliver a mask to said conveying system of said exposure apparatus side in said delivery position before the transport of said mask container to said delivery position.

83. A lithography system according to claim 82, wherein said orientation-change unit changes the orientation of said mask container during transport by said first ceiling-transport system.

84. A lithography system according to claim 82, wherein said orientation-change unit changes the orientation of said mask container while said mask is transported by a conveying system in said mask-transport-system housing.

85. A lithography system according to claim 77, wherein said delivery port is arranged below said first rail and near said exposure apparatus.

86. A lithography system according to claim 77, wherein said delivery port is arranged at a height of about 900 mm from a floor surface.

87. A lithography system according to claim 77, wherein said mask container is a sealed-type container having a lid that can be opened and closed.

88. A lithography system according to claim 87, wherein said mask container is a bottom-open-type and sealed-type container.

89. A device manufacturing method including a lithography process, wherein in said lithography process, a lithography system according to claim 77 is used.

90. A lithography system used in a clean room comprising:
an exposure apparatus that is provided on a floor surface of said clean room and transfers a pattern of a mask onto a substrate through a projection optical system;
a ceiling-transport system that moves along a rail extending on the ceiling of said clean room and transports said mask contained in a mask container;
a mask-container storeroom that has a delivery port into and from which said mask contained in said mask container is loaded and unloaded by said ceiling-transport system on the ceiling thereof;
a transport mechanism that transports said mask container carried in between said delivery port and said position in which to deliver a mask to a conveying system of said exposure apparatus side; and
an orientation-change mechanism that changes the orientation of said mask container to be suitable to deliver a mask to said conveying system of said exposure apparatus side in said delivery position before the transport of said mask container to said delivery position.

91. A lithography system according to claim 90, wherein said orientation-change mechanism changes the orientation of said mask container during transport by said ceiling-transport system.

92. A lithography system according to claim 90, wherein said orientation-change mechanism changes the orientation of said mask container during transport by said transport mechanism.

93. A lithography system according to claim 92, wherein said orientation-change mechanism is arranged in part of a path of said transport mechanism transporting said mask container.

94. A lithography system according to claim 93, wherein said orientation-change mechanism comprises a turntable on which said mask container is mounted, and a driving mechanism that rotates said turntable.

95. A lithography system according to claim 94, further comprising:
an orientation-detection mechanism that detects the orientation of said mask container mounted on said turntable, and
wherein said driving mechanism sets an angle through which said turntable is to be rotated, based on detection results of said orientation-detection mechanism.

96. A lithography system according to claim 90, wherein said orientation-change mechanism is arranged in said delivery port.

97. A lithography system according to claim 90, wherein said mask container has an opening, and said orientation-change mechanism changes the orientation of said mask container according to the direction of said opening.

98. A lithography system according to claim 97, wherein said mask container has a lid that can close said opening.

99. A device manufacturing method including a lithography process, wherein in said lithography process, a lithography system according to claim 90 is used.

100. A lithography system used in a clean room comprising:
a plurality of exposure apparatuses that are provided on a floor surface of said clean room and transfer a pattern of a mask onto a substrate through a projection optical system;
a ceiling-transport system that moves along a rail extending on the ceiling of said clean room and transports said mask contained in a mask container; and
an orientation-setting mechanism that is provided on said ceiling-transport system, and, before carrying into each of said exposure apparatuses, sets the orientation of said mask container to be suitable for said exposure apparatus.

101. A lithography system according to claim 100, wherein said orientation-setting mechanism sets the orientation of said mask container based on information, stored beforehand, concerning orientation suitable for each exposure apparatus.

102. A lithography system according to claim 100, wherein said orientation-setting mechanism sets the orientation of said mask container according to an instruction from a host unit.

103. A lithography system according to claim 100, wherein said orientation-setting mechanism sets the orientation of said mask container based on communication results with each of said exposure apparatus.

104. A lithography system according to claim 100, wherein said mask container has an opening, and said orientation-setting mechanism sets the orientation of said mask container according to the direction of said opening.

105. A lithography system according to claim 104, wherein said mask container has a lid that can close said opening.

106. A transport method with which to transport a container containing an object to be conveyed from a first position to a second position in which said object to be conveyed is delivered,
wherein during said transport, the orientation of said container is set according to a direction in which said object is delivered in said second position.

107. A transport method according to claim 106, wherein said object to be conveyed is a mask having a pattern formed thereon.

108. A transport method according to claim 106, wherein said object to be conveyed is a substrate subject to exposure onto which a predetermined pattern is transferred.

109. A transport method according to claim 106, wherein said container has an opening, and the orientation of said container is set according to the direction of said opening.

110. A transport method according to claim 109, wherein said container has a lid that can close said opening.

111. An exposure apparatus comprising:
an exposure-apparatus main body that transfers a pattern of a mask onto a substrate;
a mask-container storeroom having a carrying-in port, for a mask container, into which a mask container containing said mask is carried from a position apart from said exposure-apparatus main body;
a transport mechanism that transports said mask container carried in between said carrying-in port and a position in which to deliver a mask to a conveying system of said exposure-apparatus main body side; and
an orientation-change unit that is arranged in part of a path of said transport mechanism transporting said mask container and changes the orientation of said mask container.

112. An exposure apparatus according to claim 111, wherein said carrying-in port is a port into which said mask container is carried when an operator transfers a mask container containing said mask from said position apart from said exposure-apparatus main body.

113. An exposure apparatus according to claim 111, further comprising:
a transport system that transports a mask container containing said mask from a position apart from said mask-container storeroom to said carrying-in port.

114. An exposure apparatus according to claim 111, wherein said mask container has an opening, and said orientation-change unit changes the orientation of said mask container according to the direction of said opening.

115. An exposure apparatus according to claim 114, wherein said mask container has a lid that can close said opening.

116. A transport method with which to transport a container containing an object to be conveyed from a first position apart from an exposure-apparatus main body to a second position in which said object to be conveyed is delivered,
wherein during said transport, the orientation of said container is set according to a direction in which said object is delivered in said second position.

117. A transport method according to claim 116, wherein an operator carries a container containing said object to be conveyed from said first position to said second position.

118. A transport method according to claim 116, wherein a transport mechanism transports a container containing said object to be conveyed from said first position to said second position.

119. A transport method according to claim 116, wherein said mask container has an opening, and said orientation-change unit changes the orientation of said mask container according to the direction of said opening.

120. A transport method according to claim 119, wherein said mask container has a lid that can close said opening.
